(19) United States
(12) Patent Application Publication
(10) Pub. No.: US 2025/0052952 A1
(43) Pub. Date: Feb. 13, 2025

(54) ON-CHIP INTERFEROMETRY SYSTEM FOR HIGH SECRET KEY RATE QUANTUM KEY DISTRIBUTION BASED ON ENTANGLED PHOTONIC QUDITS

(71) Applicant: INSTITUT NATIONAL DE LA RECHERCHE SCIENTIFIQUE, QUÉBEC (CA)

(72) Inventors: STEFANIA SCIARA, MONTRÉAL (CA); NICOLA MARYANN MONTAUT, SAINT-LAMBERT (CA); YOANN JESTIN, MONTRÉAL (CA); ROBIN HELSTEN, MONTRÉAL (CA); ROBERTO MORANDOTTI, MONTRÉAL (CA)

(21) Appl. No.: 18/787,692

(22) Filed: Jul. 29, 2024

Related U.S. Application Data
(60) Provisional application No. 63/516,747, filed on Jul. 31, 2023.

(51) Int. Cl. G02B 6/293

(52) U.S. Cl. CPC G02B 6/29355

(57) ABSTRACT

Quantum photonics via quantum key distribution (QKD) offers a route to unconditional security but photon absorption, scattering, and losses have been an obstacle to implementing an untrusted-source QKD in optical fiber links in terms of distances and data rates. Whilst entangled photonic qudits offer enhanced information efficiency, noise robustness, and security level of QKD frequency and time entangled qudits promise resources to implement robust QKD in optical fibers. However, the spectral range occupied by frequency and time entangled qudits, their bandwidth, represents a significant issue towards their use for QKD applications in optical fiber networks. To implement high secret key rates for untrusted-source QKD in fiber links it is necessary to increase qudit dimensionality whilst keeping the time-bandwidth product as low as possible. However, this is a challenging task to achieve with current photonic platforms. Accordingly, it would be beneficial to provide photonic platforms that overcome the prior art limitations.

### CROSS-REFERENCE TO RELATED APPLICATIONS

This patent application claims the benefit of priority to U.S. Provisional Patent Application 63/516,747 filed Jul. 31, 2023; the entire contents of which are incorporated herein by reference.

### FIELD OF THE INVENTION

This invention is directed to quantum key distribution (QKD), specifically to untrusted-source QKD, and more specifically to photonic platforms for untrusted quantum communication sources for the generation of multi-level entangled photonic states (qudits) to support untrusted-source QKD.

### BACKGROUND OF THE INVENTION

A compelling application of quantum photonics is the implementation of quantum communications, including quantum key distribution (QKD), which has the ability to deliver unconditional security. In particular, entangled photonic qudits (a quantum version of a d-ary digit for d>2) offer a key to enhancing information efficiency, noise robustness, and security level of QKD, known as untrusted-source QKD. In this context, practical QKD systems must be implemented in fiber networks compatible with the standard telecommunication infrastructure. However, since photons cannot be amplified, issues such as the photons' absorption, scattering, and losses are an obstacle for the implementation of untrusted-source QKD in fiber links in terms of distances and data rates for secret key transmission. While significant advancements have been made towards increasing distances, with an achieved record of 1000 km, these demonstrations have made of use of twin fields rather than entangled photons, as well as have registered secret key rates limited to few bits/s. Whilst secret key rates of megabits/s have been reached in fibers via single-photon qudits, these approaches do not provide the quantum secrecy of an untrusted source, with current realizations of entanglement-based QKD still being limited to two-level photon states (qubits).

In order to overcome these limitations frequency and time entangled qudits have been proposed as promising resources to implement robust QKD in fibers, as they are less prone to decoherence, as well as are compatible with manipulation and transmission over standard telecommunication architecture. For instance, time-entangled qudits have enabled efficient teleportation and entanglement distribution over metropolitan fiber networks. Yet, the spectral range occupied by frequency and time entangled qudits, their bandwidth, represents a significant issue towards their use for QKD applications in optical fiber networks. The processable bandwidth of these qudits is still far less that of telecommunication standards (100s of Gigabits/s of data rate per channel). This gap is a consequence of the large temporal spacing between the qudit modes, which ranges typically from sub-nanoseconds to tens of nanoseconds for resonator-based platforms. A good parameter in this regard is the time-bandwidth product (TBP), which can be expressed as (d−1) ΔtΔv, where d denotes the qudit dimensionality, while Δt and Δv are the temporal and the spectral mode spacing, respectively. The TBP defines therefore defines a dimensionless area occupied by the qudits in the time and frequency domains. In order to implement high secret key rates for untrusted-source QKD in fiber links it is necessary to increase the qudit dimensionality whilst keeping the TBP as low as possible. This would yield an increase of the quantum information that can be transmitted per second through a single communication channel. Yet, this remains a challenging task to achieve with current photonic platforms.

Accordingly, it would be beneficial to provide photonic platforms that overcome limitations within the prior art in respect of the achievable TBP.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations in the prior art relating to quantum key distribution (QKD), specifically to untrusted-source QKD, and more specifically to photonic platforms for untrusted quantum communication sources for the generation of multi-level entangled photonic states (qudits) to support untrusted-source QKD.

In accordance with an embodiment of the invention there is provided device comprising: a linear series of N optical switches;
N−1 pairs of waveguides wherein each pair of waveguides of the N−1 pairs of waveguides is disposed between a predetermined optical switch of the N optical switches and a sequential optical switch of the N optical switches to the predetermined optical switch of the N optical switches; and
an optical waveguide coupled to the output of the final optical switch of the N optical switches; wherein
each pair of waveguides comprises:
   a waveguide coupled from an output port of the associated predetermined optical switch of the N optical switches and an input port of the associated sequential optical switch of the N optical switches; and
   another waveguide from another output of the predetermined optical switch of the N optical switches and another input of the associated sequential optical switch of the N optical switches introducing a predetermined delay to optical signals propagating within the another waveguide relative to those optical signals propagating within the waveguide;
the predetermined delays for the N−1 pair of waveguides are 2^{M}·T where M=0, 1 . . . . N−1 and T is a defined delay; and
N is a positive integer greater than or equal to 3.

In accordance with an embodiment of the invention there is provided a method comprising: coupling an optical pulse to an optical device to generate a series of optical pulses; and coupling the series of optical pulses generated by the optical device to an optical waveguide within
which spontaneous four-wave mixing of the series of optical pulses occurs to generate
signal quantum d-ary bits (qudits) and idler qudits; wherein

d≥2.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A depicts a photonic platform for the generation of d-level time-entangled photon states (qudits) according to an embodiment of the invention;

FIG. 1B depicts schematically the time-bandwidth product (TBP) attainable with a photonic platform according to the embodiment of the invention depicted in FIG. 1A and one exploiting microring resonators for the case of an 8-level entangled photon state;

FIG. 2A depicts schematically a simplified experimental setup for the generation of picosecond-spaced time-entangled photonic qudits exploiting the photonic platform according to the embodiment of the invention depicted in FIG. 1A;

FIG. 2B depicts the operational principle for a 4-level quantum state processing exploiting the photonic platform according to the embodiment of the invention depicted in FIG. 1A with external phase modulation;

FIG. 2C depicts a simplified schematic for 8-level quantum interference measurements exploiting the photonic platform according to the embodiment of the invention depicted in FIG. 1A;

FIGS. 3A and 3B depict measurements of two-photon quantum interferences of 4-level entangled qudits over two optical channels generated by the photonic platform according to the embodiment of the invention depicted in FIG. 1A;

FIG. 3C depicts a density matrix retrieved from quantum state tomography measurements performed with a system-tailored set of projections exploiting the photonic platform according to the embodiment of the invention depicted in FIG. 1A;

FIG. 3D depicts the measured joint temporal distribution for qudits generated by the photonic platform according to the embodiment of the invention depicted in FIG. 1A showing the correlations between the eight different time modes;

FIGS. 3E and 3F depict measured two-photon quantum interferences of 8-level entangled qudits over the same channels as those in FIGS. 3A and 3B respectively;

FIG. 4A depicts a simplified scheme for the transmission of signal photons to user setups for time and phase basis measurements employed within an embodiment of the invention and experimental results presented within this specification;

FIG. 4B depicts the measured QBER of time (phase) achieved with the photonic platform according to the embodiment of the invention depicted in FIG. 1A as transmitter with signal photons generated according to FIG. 4A;

FIG. 4C depicts the measured secret key rate with external temporal filtering achieved with the photonic platform according to the embodiment of the invention depicted in FIG. 1A as transmitter with idler photons generated according to FIG. 4A;

FIG. 4D depicts secret key rates for 2-level and 4-level quantum key distribution (QKD) with external temporal filtering achieved with the photonic platform according to the embodiment of the invention depicted in FIG. 1A as transmitter with idler photons generated according to FIG. 4A;

FIG. 5 depicts schematics of experimental modules for quantum state generation and processing exploiting the photonic platform according to the embodiment of the invention depicted in FIG. 1A;

FIG. 6 depicts an experimental setup for untrusted-source QKD tests based on 4-level entangled qudits;

FIG. 7 depicts a schematic of an on-chip interferometer cascade (OIC) which can form part of the photonic platform according to the embodiment of the invention depicted in FIG. 1A;

FIG. 8A depicts measured quantum interference on a channel exploiting photonic platforms according to embodiments of the invention;

FIG. 8B depicts a density matrix retrieved from quantum state tomography with a photonic platform according to the embodiment of the invention depicted in FIG. 1A;

FIG. 9A depicts signal and idler photons propagating each over a 20 km single-mode fiber (SMF) and 10 km dispersion-compensating fiber (DCF) to mimic two users separated by 60 km within experiments performed with a photonic platform according to the embodiment of the invention depicted in FIG. 1A; and

FIGS. 9B and 9C depict measured quantum interferences for 2-level and 4-level entangled photon pairs respectively with the experimental configuration depicted in FIG. 9A with the photonic platform according to the embodiment of the invention depicted in FIG. 1A.

### DETAILED DESCRIPTION

The present invention is directed to quantum key distribution (QKD), specifically to untrusted-source QKD, and more specifically to photonic platforms for untrusted quantum communication sources for the generation of multi-level entangled photonic states (qudits) to support untrusted-source QKD

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It would be understood by one of skill in the art that various changes can be made in the function and arrangement of elements without departing from the scope of the invention as set forth in the claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment,” “an embodiment,” “some embodiments” or “other embodiments” means that a particular feature, structure, or characteristic described in connection with the embodiments is included in at least one embodiment, but not necessarily all embodiments, of the invention. The phraseology and terminology employed herein is not to be construed as limiting but is for descriptive purposes only. It is to be understood that where the claims or specification refer to “a” or “an” element, such reference is not to be construed as there being only one of that element. It is to be understood that where the specification states that a component feature, structure, or characteristic “may,” “might,” “can” or “could” be included, that particular component, feature, structure, or characteristic is not required to be included.

Reference to terms such as “left,” “right,” “top,” “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including,” “comprising,” “consisting” and grammatical variants thereof do not preclude the addition of one or more components, features, steps, integers or groups thereof and that the terms are not to be construed as specifying components, features, steps or integers. Likewise, the phrase “consisting essentially of,” and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional elements.

A “two-dimensional” waveguide, also referred to as a 2D waveguide or a planar waveguide, as used herein may refer to, but is not limited to, an optical waveguide supporting propagation of optical signals within a predetermined wavelength range which guides the optical signals vertically relative to a substrate upon which the 2D waveguide is formed but does not guide the optical signals laterally relative to the propagation direction of the optical signals within the 2D waveguide.

A “three-dimensional” waveguide, also referred to as a 3D waveguide, a channel waveguide, or simply waveguide as used herein may refer to, but is not limited to, an optical waveguide supporting propagation of optical signals within a predetermined wavelength range which guides the optical signals vertically relative to the substrate upon which the 3D waveguide is formed as well as laterally relative to the propagation direction of the optical signals within the 3D waveguide.

A “photonic integrated circuit” (PIC) as used herein may refer to, but is not limited to, the monolithic integration of multiple integrated optics devices into a circuit formed upon a common substrate providing an optical routing and processing functionality. The PIC is fabricated using processing techniques at a wafer level, e.g. CMOS manufacturing flows, MEMS processing flows, etc.

The “O-band” as used herein refers to, but is not limited to, the wavelength range 1260-1360 nm. The “E-band” as used herein refers to, but is not limited to, the wavelength range 1360-1460 nm. The “C-band” as used herein refers to, but is not limited to, the wavelength range 1530-1565 nm. The “S-band” as used herein refers to, but is not limited to, the wavelength range 1460-1530 nm. The “L-band” as used herein refers to, but is not limited to, the wavelength range 1565-1625 nm. The “U-band” as used herein refers to, but is not limited to, the wavelength range 1625-1675 nm.

Within the embodiments of the invention the inventors refer to the term “hybridly integrated.” This may, within some embodiments of the invention, refer to, but not be limited to, the “integration” of an optical element onto a substrate by attaching the optical element or another element physically integrated with the optical element to the substrate (platform) such that the optical element is retained in position. Such attachment means may include, but not be limited to, soldering, epoxy, van der Waals forces, electrostatic attachment, magnetic attachment, physical interlocking and friction. Accordingly, in these embodiments of the invention the optical element being hybridly integrated may be viewed as being implemented within a parallel manufacturing process to the other optical element(s) prior to being co-assembled. This parallel manufacturing process may employ one or more processes selected from the group comprising, but not limited to, liquid phase epitaxy (LPE), metal organic chemical vapor deposition (MOCVD), organometallic vapor-phase epitaxy (OMVPE), selective area epitaxy, an additive manufacturing process, a non-additive manufacturing process, crystal growth, doping, induced damage, etching, doping and deposition.

This may, within other embodiments of the invention, refer to, but not be limited to, the “integration” of an optical element onto a substrate using a different manufacturing methodology and/or techniques to those employed in forming other optical components upon the substrate. For example, this may employ an LPE process to form the other optical element upon the substate wherein the optical component upon the substrate was formed by MOCVD or vice-versa. Alternatively, both the optical component and other optical component may be formed using the same manufacturing methodology or a combination of manufacturing methodologies. These manufacturing methodologies may employ one or more processes selected from the group comprising, but not limited to, LPE, MOCVD, OMVPE, selective area epitaxy, an additive manufacturing process, a non-additive manufacturing process, crystal growth, doping, induced damage, etching, doping, deposition, an additive manufacturing process and a non-additive manufacturing process. Accordingly, in these embodiments of the invention the optical element being hybridly integrated may be viewed as being implemented within one or more further processing stages of the same manufacturing process as the other optical element(s). However, in each instance the optical waveguide and/or optical component properties require that an optical interface is implemented between the optical waveguide and optical component in order to provide efficient optical coupling between one and the other.

Within the embodiments of the invention the inventors refer to the term “monolithically integrated.” This may, within some embodiments of the invention, refer to, but not be limited to, the “integration” of optical elements onto or within a substrate directly forming each optical component onto or within the substrate (platform). The manufacturing processes for the optical elements may be concurrent, plesiochronous or asynchronous. Each optical element may be formed from one or more processes selected from the group comprising, but not limited to, LPE, MOCVD, OMVPE, selective area epitaxy, an additive manufacturing process, a non-additive manufacturing process, crystal growth, doping, induced damage, etching, doping and deposition.

An optical element may employ one or more semiconductors grown using LPE, MOCVD, and OMVPE, for example. The one or more semiconductors may be selected from, but not limited to, group III-V semiconductors, group II-VI semiconductors, group IV semiconductors, and group IV-V-VI semiconductors. Examples of group III-V semiconductors may include AlP, AlN, AlGaSb, AlGaAs, AlGaInP, AlGaN, AlGaP, GaSb, GaAsP, GaAs, GaN, GaP, InAlAs, InAlP, InSb, InGaSb, InGaN, GalnAlAs, GalnAIN, GalnAsN, GalnAsP, GalnAs, GalnP, InN, InP, InAs, InAsSb, and AlInN. Examples of group II-VI semiconductors may include ZnSe, HgCdTe, ZnO, ZnS, and CdO. Examples of group IV Semiconductors may include Si, Ge, and strained silicon. A group IV-V-VI semiconductor may be GeSbTe.

Within embodiments of the invention the platform or substrate upon which the integration is performed may be a silicon substrate wherein the one or more optical waveguides upon the platform exploit a silicon nitride core with silicon oxide upper and lower cladding, a SiO₂—Si₃N₄—SiO₂ waveguide structure. Alternatively, the one or more optical waveguides may employ a silicon core with silicon nitride upper and lower claddings. Optionally, the upper cladding may be omitted within other embodiments of the invention.

However, it would be evident that other optical waveguide structures may be employed including, but not limited to, silica-on-silicon, doped (e.g., germanium, Ge) silica core with undoped cladding, silicon oxynitride, polymer-on-silicon, or doped silicon waveguides for example. Additionally, other waveguide structures may be employed including vertical and/or lateral waveguide tapers and forming microball lenses on the ends of the waveguides via laser and/or arc melting of the waveguide tip.

Further, whilst embodiments of the invention are described with respect to silicon-on-insulator (SOI) waveguides by way of example, e.g. SiO₂—Si₃N₄—SiO₂; SiO₂—Ge: SiO₂—SiO₂; or Si—SiO₂; it would be evident that within other embodiments of the invention may be employed to coupled passive waveguides to active semiconductor waveguides, such as indium phosphide (InP) or gallium arsenide (GaAs), e.g. a semiconductor optical amplifier (SOA), laser diode, etc. Optionally, an active semiconductor structure may be epitaxially grown onto a silicon IO-MEMS structure, epitaxially lifted off from a wafer and bonded to a silicon integrated optical microelectromechanical systems (IO-MEMS) structure, etc.

However, within other embodiments of the invention a variety of waveguide coupling structures coupling onto and/or from waveguides employing material systems that include, but not limited to, SiO₂—Si₃N₄—SiO₂; SiO₂—Ge: SiO₂—SiO₂; Si—SiO₂; ion exchanged glass, ion implanted glass, polymeric waveguides, InGaAsP, GaAs, III-V materials, II-VI materials, and optical fiber. Whilst primarily waveguide-waveguide systems have been described it would be evident to one skilled in the art that embodiments of the invention may be employed in aligning intermediate coupling optics, e.g., ball lenses, spherical lenses, graded refractive index (GRIN) lenses, etc. for free-space coupling into and/or from a waveguide device.

Further, whilst embodiments of the invention are described primarily with respect to a silicon substrate it would be evident that other substrates may be employed within other embodiments of the invention. These may include, but not be limited to, a semiconductor, a ceramic, a metal, an alloy, a glass, or a polymer.

A “ceramic” as used herein may refer to, but is not limited to, an inorganic, nonmetallic solid material comprising metal, non-metal or metalloid atoms primarily held in ionic and covalent bonds. Such ceramics may be crystalline materials such as oxide, nitride or carbide materials, elements such as carbon or silicon, and non-crystalline. Exemplary ceramics may include high temperature ceramics or high temperature co-fired ceramics such as alumina (Al₂O₃), zirconia (ZrO2), and aluminum nitride (AlN) or a low temperature cofired ceramic (LTCC). A LTCC may be formed from a glass-ceramic combination.

A “glass” as used herein may refer to, but is not limited to, a non-crystalline amorphous solid. A glass may be fused quartz, silica, a soda-lime glass, a borosilicate glass, a lead glass, an aluminosilicate glass for example. A glass may include other inorganic and organic materials including metals, aluminates, phosphates, borates, chalcogenides, fluorides, germanates (glasses based on GeO2), tellurites (glasses based on TeO2), antimonates (glasses based on Sb2O3), arsenates (glasses based on As2O3), titanates (glasses based on TiO2), tantalates (glasses based on Ta2O5), nitrates, carbonates, plastics, and an acrylic.

Further, whilst the embodiments of the invention are described and depicted with respect to a waveguide employing a core embedded within a cladding, a so-called buried waveguide, it would be evident that other waveguide geometries such as rib waveguide, diffused waveguide, ridge or wire waveguide, strip-loaded waveguide, slot waveguide, and anti-resonant reflecting optical waveguide (ARROW waveguide), photonic crystal waveguide, suspended waveguide, alternating layer stack geometries, sub-wavelength grating (SWG) waveguides and augmented waveguides (e.g. Si—SiO₂—Polymer). Further, whilst the embodiments of the invention are described and depicted with respect to a step-index waveguide it would be evident that other waveguide geometries such as graded index and hybrid index (combining inverse-step index and graded index) may be employed.

As outlined above prior art approaches do not provide for the quantum secrecy of an untrusted source, with current realizations of entanglement-based QKD still being limited to two-level photon states (qubits). As noted frequency and time entangled qudits have been proposed as promising resources to implement robust QKD in fibers, as they are less prone to decoherence, as well as are compatible with manipulation and transmission over standard telecommunication architecture. However, the spectral range occupied by frequency and time entangled qudits, their bandwidth, represents a significant issue towards their use for QKD applications in optical fiber networks.

As noted the time-bandwidth product (TBP), which can be expressed as (d−1)ΔtΔv, where d denotes the qudit dimensionality, while Δt and Δv are the temporal and the spectral mode spacing respectively, defines a dimensionless area occupied by the qudits in the time and frequency domains. In order to implement high secret key rates for untrusted-source QKD in fiber links it is necessary to increase the qudit dimensionality whilst keeping the TBP as low as possible. This yields an increase in the quantum information that can be transmitted per second through a single communication channel.

Within the prior art photonic sources for QKD have been established based upon microrings for generating and multi-arm interferometers for processing. The former have comb spacings of tens to hundreds of GHz, with nanoseconds of photon lifetime, resulting in TBPs of several hundreds to few thousands. Multi-arm interferometers suffer from phase instability, timing inaccuracy, and low processing speeds.

Accordingly, the inventors have established a photonic platform, employing a photonic integrated circuit (PIC), which enables the generation and processing of picosecond-spaced time-entangled qudits within a telecommunications band such as the O-band, E-band, C-band, L-band and U-band for example. However, other wavelength ranges may be employed such as the 850 nm band.

Within the embodiments of the invention the photonic platform enables the generation and processing of picosecond-spaced time-entangled qudits and when combined with external phase modulation the inventors demonstrate a proof-of-principle untrusted-source QKD in fibers based on entangled qudits. The novel photonic platform supports lower TBP than prior art and demonstrates robustness and versatility for long-distance quantum communications within an experimental proof-of-concept demonstration by implementing untrusted-source QKD over 60 km of standard telecommunication fibers between two clients.

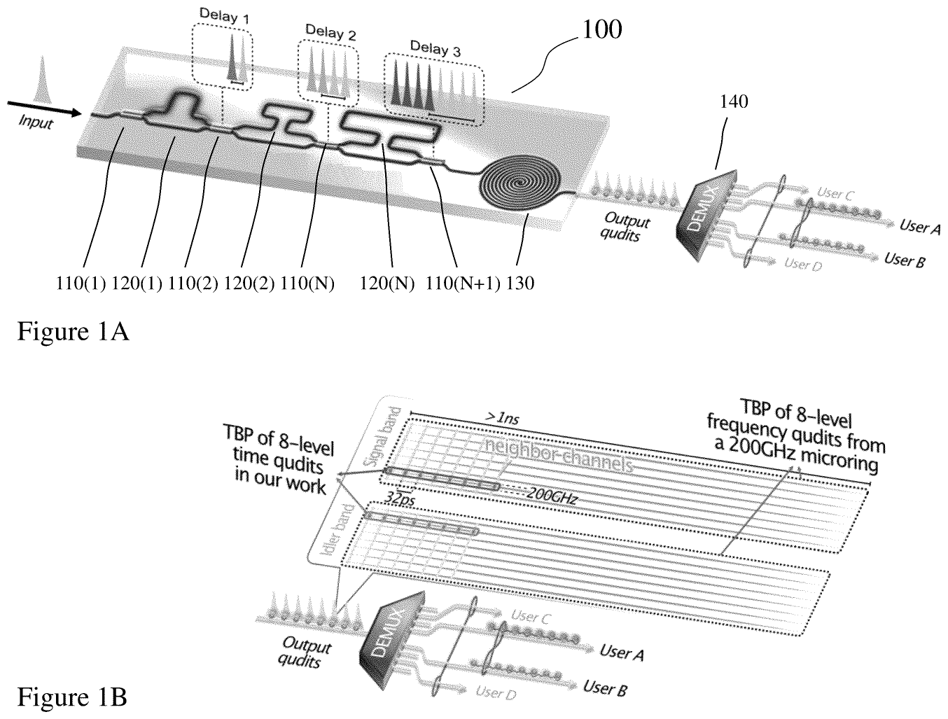

Referring to FIG. 1A there is depicted a schematic of a photonic platform for the generation of d-level time-entangled photon states (qudits) according to an embodiment of the invention employing an optical interferometer cascade (OIC) within a photonic integrated circuit (PIC). As depicted the OIC employs a switchable cascade of unbalanced Mach-Zehnder interferometers (MZIs) where the output is coupled to a spiral waveguide. The switchable cascade of MZIs is employed to split an input pump (input pulse) into a train of pulses, whose temporal separation is defined by the different interferometric path lengths the input pump is coupled to through the switchable cascade of MZIs. The burst, train of pulses, are then coupled to the spiral waveguide such that they generate signal and idler photonic qudits via spontaneous four-wave mixing. These generated qudits are then individually distributed to multiple users by accessing different frequency channels through a demultiplexing scheme using a demultiplexer (DEMUX or DMUX).

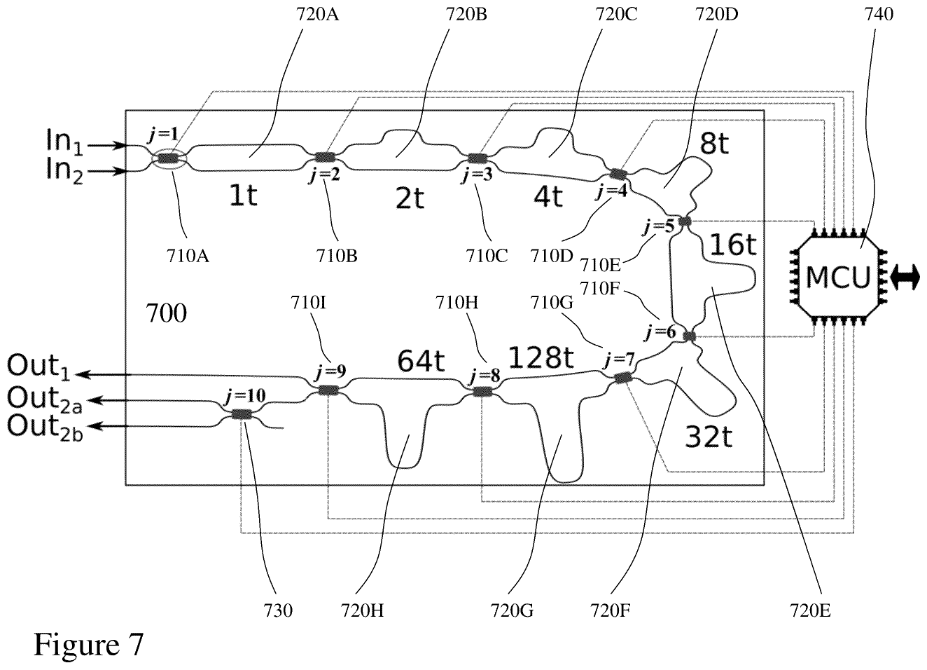

A PIC implementation using integrated photonic waveguides benefits from the advanced lithographic fabrication techniques and other processes leveraged from semiconductor manufacturing to form multiple photonic components such as MZIs, optical waveguides etc. into an optical circuit (PIC) where multiple PICs can be concurrently manufactured within a single wafer. Beneficially such PICs lead to short optical paths, low phase drifts, and delay times of a few picoseconds. The OIC consists of an electronically switchable sequence of multiple unbalanced Mach-Zehnder interferometers (MZIs) in a waveguide connected cascade as depicted in FIG. 1 and FIG. 7. To generate time-entangled qudits, the inventors exploit the OIC to provide a multi-path optical splitter.

As depicted in FIG. 1A the OIC 100 comprises a series of MZIs 110(1) to 110(N+1) between which are disposed pairs of waveguides (waveguide pairs) 120(1) to 120(N) where the output of the final MZI 110(N+1) is coupled to the spiral waveguide (SW) 130. The first MZI 110(1) selects either a waveguide coupled to the next MZI 110(2) directly (direct path) or the other waveguide which also couples to the next MZI 110(2) but with a time delay relative to the direct path of t (delayed path). The second MZI 110(2) then couples the optical pulse, from either the direct path or delayed path, to either the next direct path or next delayed path in the next waveguide pair 120(2) where the delayed path is now 2τ. This repeats wherein each subsequent delayed path is double the preceding delayed path until the final pair of waveguides 120(N) where the delayed path is now Rτ where R=2N⁻¹, i.e. R=8 for N=4, R=32 for N=6 etc. The resulting burst, train of pulses, from the series of MZIs 110(1) to 110(N+1) and pairs of waveguides (waveguide pairs) 120(1) to 120(N) are then coupled to the Spiral Waveguide 130 such that they generate signal and idler photonic qudits via spontaneous four-wave mixing. These generated qudits are then individually distributed to multiple users by accessing different frequency channels through a demultiplexing scheme using a demultiplexer (DEMUX or DMUX) 140.

Whilst OIC 100 is depicted and described with a series of MZIs 110(1) to 110(N+1) between which are disposed pairs of waveguides 120(1) to 120(N) such that the delays are additively selected or bypassed by the states of the MZIs it would be evident that alternatively other configurations of switches and time delays may be employed. For example, a 1×M switch could be employed to select one of M waveguides where the M (M=2^{N}) waveguides are coupled to an M×1 switch wherein each waveguide of the M waveguides has a specific defined delay of the M delays required for the N-level states. Within other embodiments of the invention other switch/delay element configurations may be employed without departing from the scope of the invention.

Similarly, whilst OIC 100 in FIG. 1A is depicted as employed MZIs it would be evident that other optical switch elements may be employed to provide the 1×2 switch functionality at the input to first waveguide pair 120(1), the 2×1 switch functionality after the final waveguide pair 120(N) and the 2×2 switch functionality in the intermediate stages. These may for example be directional coupler (DC) switches, zero-gap DC switches, digital optical switches (DOSs), multimode interference (MMI) switches etc.

Specifically, by activating selected MZIs, an input laser pulse can be split into a coherent train of d pulses with equal amplitudes and discrete spacing. This enables the passive generation of precisely spaced d-fold pulse bursts at the wavelength of the optical input pulse which are generated, for example, by a mode-locked semiconductor diode laser (SDL). Depending upon the technologies of the PIC and mode-locked SDL these may be monolithically or hybridly integrated or interconnected via optical fiber although added complexity from polarisation issues/polarisation control may arise in this scenario.

The generated pulse train experiences optical amplification, ultrafast phase modulation, and spectral filtering before it is launched into the spiral waveguide. Within the spiral waveguide spontaneous four-wave mixing is induced, which generates d-level (qudit) time-entangled photon pairs comprising signal photons, s, and idler photons, i. Within the experimental embodiments of the invention the optical pulses and qudit photon pairs are within the telecommunication C band although it would be evident that within other embodiments of the invention these may be within other bands including, but not limited to, the _band, E-band, S-band and L-band depending upon the optical telecommunications infrastructure the qudits are transmitted over.

The states of these d-level (qudit) time-entangled photon pair are of the form given by Equation (1) where k represents different time modes, while the coefficient e^{iθk} describes the relative phases between the prepared pulses.

$${{\vert ψ 〉 = \frac{1}{\sqrt{d}} {\sum }_{k = 0}^{d - 1} {e}^{i {θ}_{k}} \vert k 〉}_{s} \vert k 〉}_{i} \qquad ( 1 )$$

The inventors as described below have employed this photonic platform and scheme to generate 4- and 8-level entangled photon pairs with time mode spacings of 64 ps and 32 ps, respectively. Within a 200 GHz frequency channel spacing of a commercially available dense wavelength-division multiplexing (DWDM) network this would allow time-entangled photonic qudits with dimensionalities of 42 and 82 respectively. The resulting TBPs being 3×0.064ns×200 GHz=35.8 and 7×0.032ns×200 GHz=44.8 for 4- and 8-level states, respectively. For comparison, microring resonators generating combs of 200 GHz spacing and photons of 4 ns lifetime reported within the prior art yield TBPs as high as 2,400 and 5,600 for 4- and 8-level states, respectively.

This comparison being depicted in FIG. 1B where the signal and idle 8-level time qudits are schematically depicted 32 ps apart relative to part of the equivalent 8-level qudits from a 200 GHz microring.

In order to undertake quantum state characterization and entanglement verification the inventors performed quantum interference and quantum state tomography (QST) measurements. In order to achieve this the inventors accessed the individual time modes by means of temporal filtering, as well as superimposing them through coherent mixing after arbitrary phase control as outlined below. The individual time modes define the computational basis (hereinafter referred to as time basis), while their superposition defines the phase basis.

In the experiments the inventors employed an external fiber-based phase modulator driven by a programmable arbitrary waveform generator before the OIC for processing the quantum states. This allowed the inventors to coherently mix the time qudits at ultrafast speeds without modifying the OIC configuration. External phase modulation offers the benefit advantage of fixed optical losses independent of the quantum state dimensionality. Within the experiments undertaken this was approximately 12.5 dB overall for the processing setup.

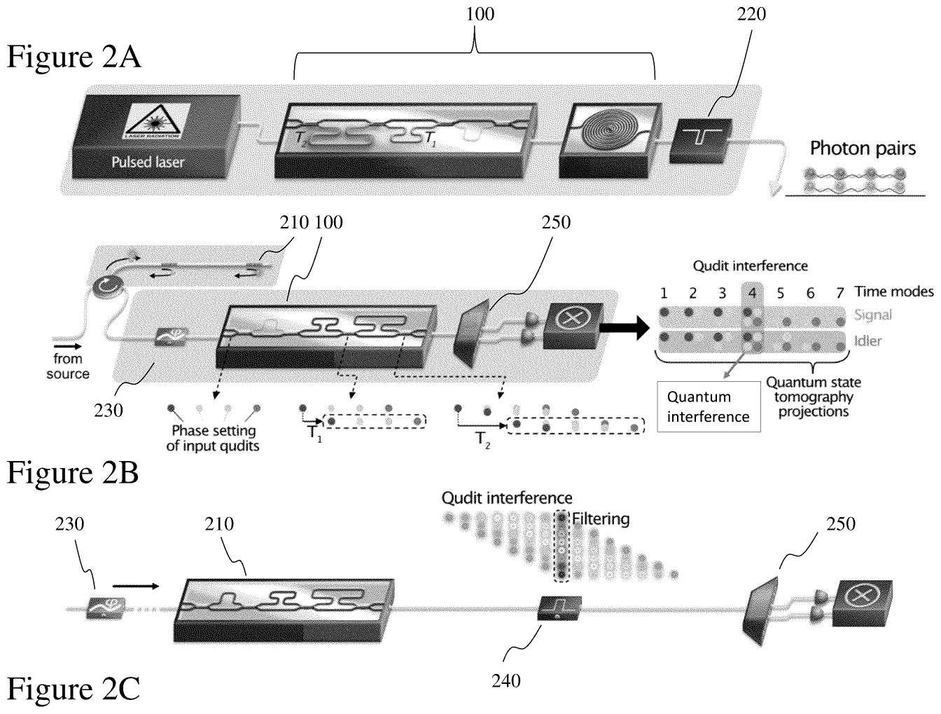

In order to generate and process a 4-level entangled state, the inventors configured the OIC in such a way to activate two cascaded MZIs and consequently produce a train of four pulses with 64 ps spacing. This burst was used to pump the spiral waveguide to generate a 4-level entangled photon state of the form given by Equation (2) and as depicted schematically in FIG. 2A where a simplified experimental setup for the generation of picosecond-spaced time-entangled photonic qudits exploiting the OIC and spiral waveguide (SW) id depicted.

$${{\vert Ψ 〉 = \frac{1}{2} {\sum }_{k = 0}^{3} {e}^{i {θ}_{k}} \vert k 〉}_{s} \vert k 〉}_{i} \qquad ( 2 )$$

In order to address (bypass) the 45ps-jitter time limitation of the superconducting nanowires single-photon detectors (SNSPDs) employed within the experiments by the inventors, the inventors utilized external ultrashort temporal filtering on the signal and idler photons thereby suppressing photon counts from neighbouring events as depicted in FIG. 2B for 4-level quantum state processing. Accordingly, by gating the central time mode out of seven superposition events from the OIC, the inventors were able to measure quantum interference as depicted in FIG. 2C for 8-level quantum interference measurements. Within FIG. 2B the operation principle for 4-level quantum state processing by using the OIC 100 and external phase modulation is depicted and is described below. Within FIG. 2C the simplified schematic for 8-level quantum interference measurements is depicted where the phase of each photons' time mode was simultaneously prepared by applying phase modulation to the pump before pulse generation/four-wave mixing. The position of the phase modulator (PM) is indicated in FIGS. 2B and 2C respectively for completeness. The inventors applied temporal filtering to separate the central interference modes in such a way to bypass the issue of the time mode spacing (i.e., 32 ps) approaching the jitter time of the superconducting nanowire single-photon detectors (i.e., 45 ps). Accordingly in FIGS. 2B and 2C there are depicted the OIC 100 comprising the on-chip interferometer cascade and spiral waveguide (not depicted for clarity), fibre Bragg gratings (FPGs) 210, notch filter (NF) 220, phase modulator (PM) 230; intensity modulator (IM) 240 and demultiplexer (DEMUX) 250.

Within the experiments performed by the inventors as described and depicted below in order to show the compatibility of the inventive platform for telecommunication applications, the inventors selected two signal-idler pairs over the C band, specifically, channels H22-H30 (corresponding to 1,559.39 nm and 1,552.93 nm, respectively) and channels H20-H32 (corresponding to 1,561.01 nm and 1,551.32 nm, respectively).

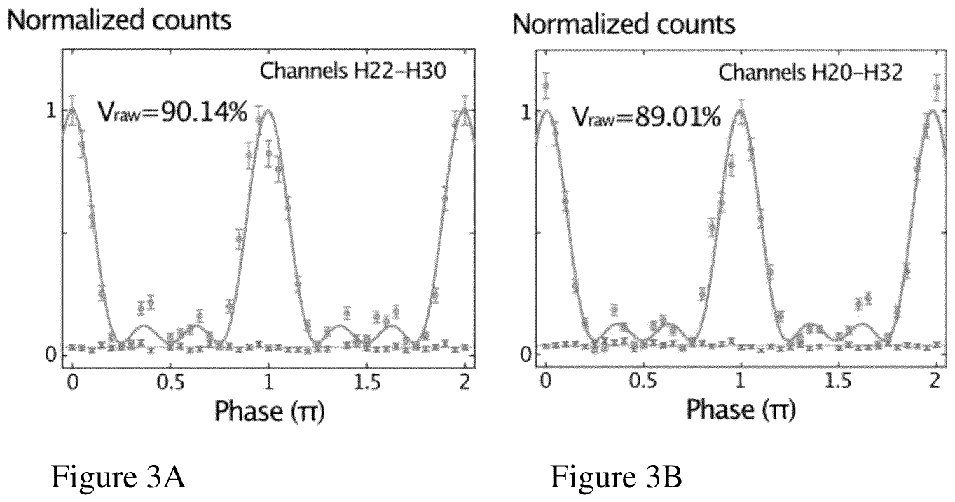

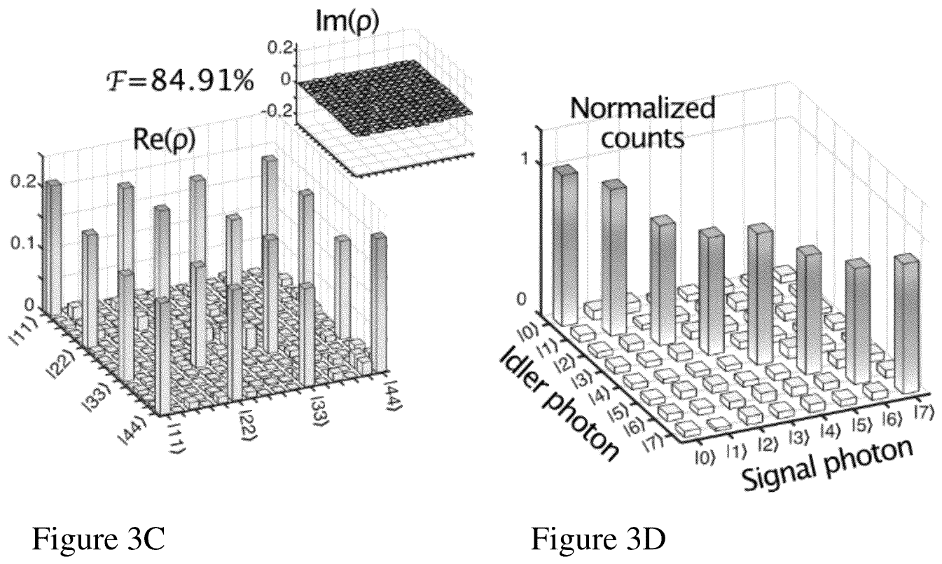

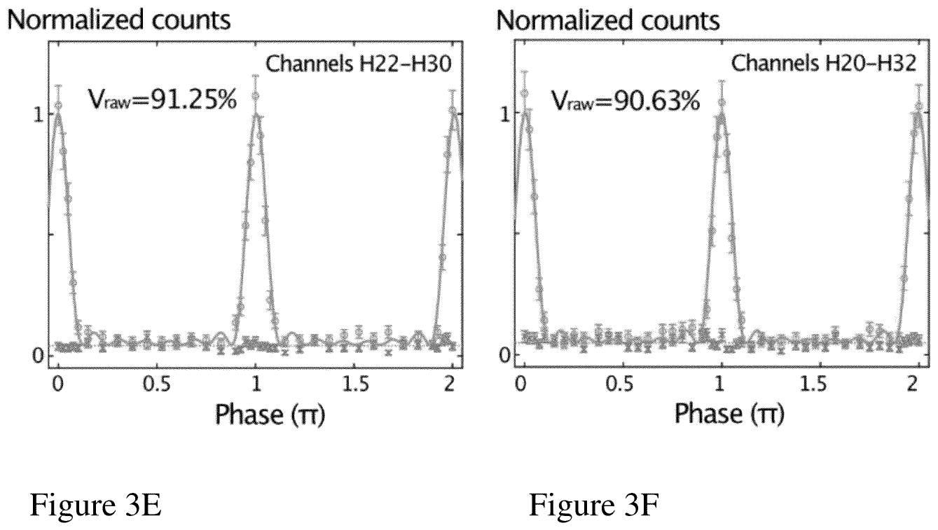

Referring to FIGS. 3A and 3B there are depicted measurements of two-photon quantum interferences of 4-level entangled qudits over two optical channels generated by the photonic platform according to the embodiment of the invention depicted in FIG. 1A. Accordingly, the inventors measured raw visibilities of 90.14% and 89.01% per signal-idler pair (channels H22-H30 and H20-H32, respectively), which, after background noise subtraction, became 97.89% and 97.51%, respectively. These values exceeded the threshold of 81.70% necessary to violate the 4-level Bell's inequality.

With respect to the quantum state tomography (QST) the inventors used the complete set of quantum state projections that were experimentally accessible with their prototype inventive system. This allowed them to perform only 144 measurements for the reconstruction of the quantum state density matrix yet obtaining all the 256 combinations typically required for full QST. These results are depicted in FIG. 3C where the density matrix retrieved from the QST measurements performed with the system-tailored set of projections exploiting the photonic platform according to the embodiment of the invention depicted in FIG. 1A are depicted. The inventors retrieved with a fidelity of 84.91% (evaluated through maximum likelihood estimation), which indicates good agreement between the ideal and measured entangled states. From the QST the inventors further estimated the logarithmic negativity LN (P), an entanglement monotone used to measure the entanglement of a two-partite quantum system. The obtained value was 1.5477, indicating that the 4-level entangled photon pairs carried more than 1 ebit of quantum information. The ideal value of LN(ρ) being 2 in the case of d=4. An ebit being defined as one unit of two-partite entanglement, that is, the amount of entanglement that is contained into a maximally entangled two-partite states (i.e., a Bell state).

In FIG. 3D the joint temporal distributions measured by the inventors are depicted showing the correlations between the eight different time modes. FIGS. 3E and 3F depict the measured two-photon quantum interferences of 8-level entangled qudits over the H22-H30 and H20-H32 channels, respectively. Extracted raw visibilities of 91.25% and 90.63%, respectively, were obtained which both exceeded the threshold necessary to violate 8-level Bell's inequality (i.e., 89.56%). The markers evident towards the bottom of each plot correspond to accidental coincidences and were used to evaluate the background noise subtracted visibilities.

The inventors subsequently performed experiments to demonstrate the applicability of their inventive photonic platform for telecommunication compatible quantum communications by implementing a proof-of-principle untrusted-source QKD based on 4-level entangled qudits. Within the QKD tests, two clients, referred to as Alice and Bob, each receive photons from an entangled photon source (i.e., untrusted). According to the exemplary protocol, Alice and Bob randomly choose a basis to be selected among two mutually unbiased bases (the time and phase basis) with which to measure their respective photon.

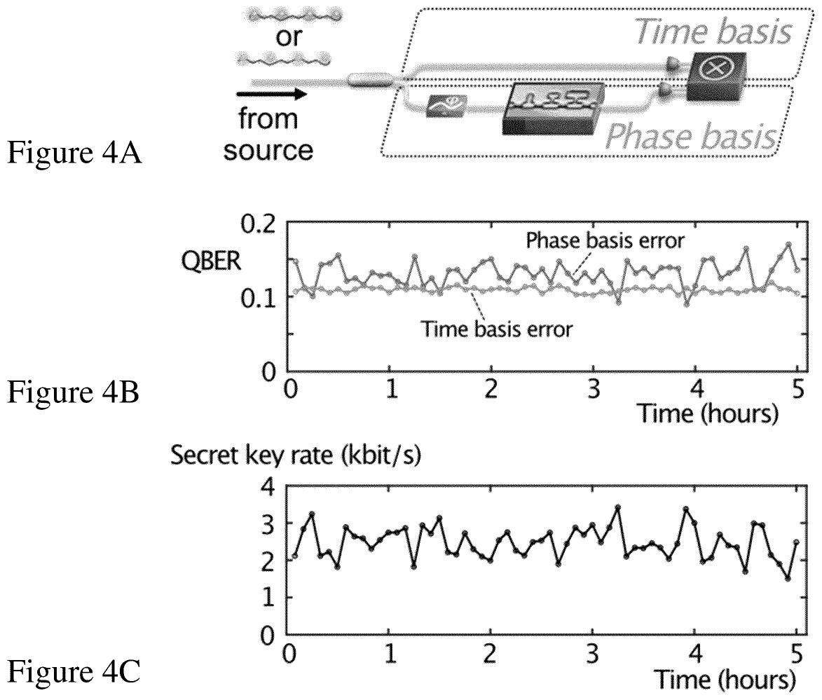

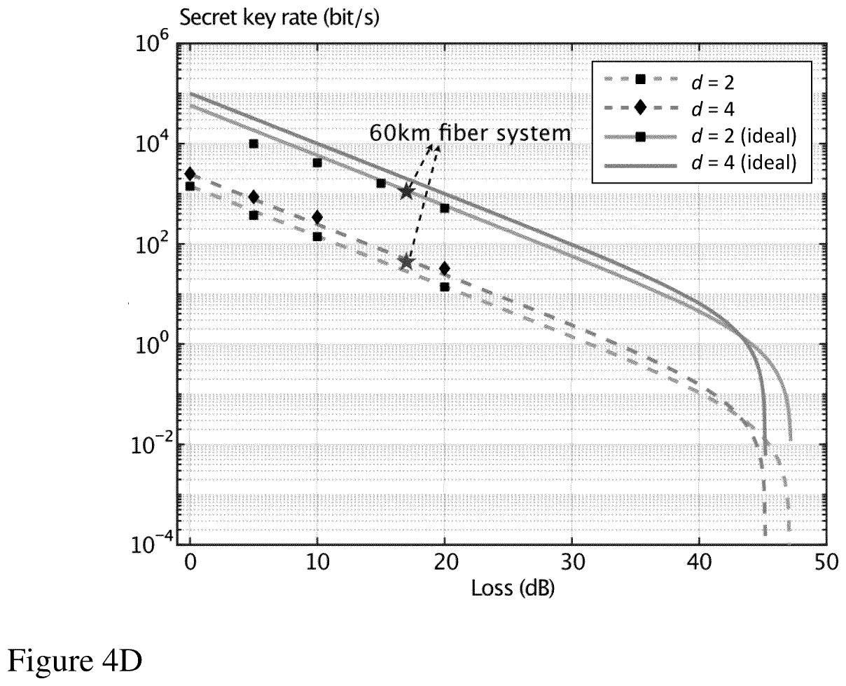

FIG. 4A depicts a simplified schematic showing the transmission of signal (idler) photon to Alice (Bob) receiver setups for time and phase basis measurements. For simplicity, only one of the measurement setups is shown. The photons passed through a beam splitter to randomly experience either the time or the phase basis. For time basis measurements, the inventors projected the qudits into one of the time modes by direct detection. For phase basis measurements, the inventors projected the qudits into one of the phase vectors by using a phase modulator and the OIC.

Alice and Bob then use the measurement outcomes to establish the secret key and to identify any eavesdropping action by using a sifting procedure (conversely, the sifted keys, as outlined below. The security of the untrusted-source QKD protocol was verified from measurements in both the time and the phase bases, where ˜1.6% of the events were used for the time basis, and all events were used for the phase basis to compensate the higher losses given by phase-projections. The entangled-qudit QKD experiment ran for 5 hours, yielding an average secret key rate of 2.47 kbits/s. The plot of this being depicted in FIG. 4B where the QBER of time (phase) basis is plotted for the 5 hour duration with an overall average error of eₜ=10.91% (e_{f}=13.05%).

FIG. 4C depicts the measured secret key rates over the 5 hours showing an overall average key rate of 2.47 kbit/s (equivalent to 100.9 kbits/s with an external temporal filtering system, see below) where each data point represents 5 minutes of acquisition time.

The full capacity of the inventors untrusted-source qudit QKD scheme can potentially reach a secret key rate of 100.9 kbits/s when using state-of-the-art SNSPDs with lower jitter time (e.g., <20 ps). The measured average quantum bit error rate (QBER) was 11.98%, well within the QBER threshold of 18.93% for 4-level QKD. The maximum state secret key rates etc. stated are not fundamentally limited with the inventive photonic platform but are defined by the parameters employed in the design of the photonic platform, e.g. number of levels, pulse spacing etc.

The inventors further verified the robustness of the entangled qudits generated by their inventive photonic platform by transmitting the generated states over a 60 km link of standard telecommunication optical fiber. Quantum interference measurements demonstrated a raw visibility of 89.49%, indicating that the entanglement was well preserved after propagation. The inventors further implemented untrusted-source QKD using this fiber link and obtained an average QBER of 11.29%, as well as a secret key rate of 42 bit/s, scalable to 2 kbits/s without considering the external temporal filtering system.

Referring to FIG. 4D there are depicted secret key rates for 2-level and 4-level quantum key distribution (QKD) with external temporal filtering achieved with the photonic platform according to the embodiment of the invention depicted in FIG. 1A as transmitter with idler photons generated according to FIG. 4A. Within FIG. 4D the secret key rates for 2-level and 4-level QKD are plotted versus channel loss. The square and diamond markers show the experimental data acquired for 2-level and 4-level QKD, respectively, when external temporal filtering was applied. The circle markers represent the experimental data for 2-level QKD without external temporal filtering, thus not experiencing the loss of this system. This enhances the key rates by a factor of 40.84, which matches the estimated efficiency of 2.51% for the external temporal filtering system. The star markers represent experimental data with 60 kms of fiber (17 dB loss) added to the system. The source is operating at a mean generation probability of μ≈0.07 for all QKD implementations. The dashed and solid lines show results from simulations.

Subsequently, the inventors demonstrated the scalability of their photonic platform by generating and processing 8-level entangled qudits. To this end, we activated three cascaded MZIs (that is, just one additional MZI with respect to the 4-level state preparation scheme), which produced a train of eight 32 ps-spaced pump pulses. This burst was used to pump the spiral waveguide, yielding the generation of an entangled state of the form given by Equation (3).

$${{\vert Ψ 〉 = \frac{1}{2 \sqrt{2}} {\sum }_{k = 0}^{7} {e}^{i {θ}_{k}} \vert k 〉}_{s} \vert k 〉}_{i} \qquad ( 3 )$$

By adopting the same temporal filtering technique used for the 4-level case, the inventors retrieved the joint temporal distribution revealing the correlations between the eight different time modes as depicted in FIG. 3F. The inventors measured quantum interference by filtering the central time mode out of the fifteen superposition events from the OIC (see FIG. 2C). For the H22-H30 and H20-H32 channels, the inventors extracted raw visibilities of 91.25% and 90.63% respectively, which, after background noise subtraction, became 99.18% and 99.99%, respectively (see FIGS. 3E and 3F respectively). In both cases, the inventors exceeded the 89.56% threshold necessary for 8-level Bell's inequality violation.

Accordingly, as described above and below the inventors have demonstrated a photonic platform employing cascaded switching and delay stages that enables the generation and processing of picosecond-spaced time-entangled qudits within a TBP as low as 35.8. The inventors have demonstrated proof-of-concept untrusted-source QKD based on 4-level entangled qudits and measured the record high secret key rate of 2.47 kbits/s obtained in fiber networks with entangled photons thus far. This value can be scaled to 100.9 kbit/s when using low-jitter detection modules. The photonic platform is resource efficient and takes advantage of the inherent security given by entanglement in terms of untrusted sources, in contrast to prior art approaches employing 4-level single-photons. For comparison, the inventors utilized two SNSPDs for phase basis measurements, while the other approach necessitated the use of four detectors per receiving client. Furthermore, assuming state-of-the-art timing resolution of sub-3 ps, mode spacing of 4 ps, and a pump rate of 62.5 GHz, the secret key rate enabled by our scheme can be scaled to 1.61 Megabits/s, that is, the same order of magnitude as those registered with QKD based on single-photon qudits. Additionally, when employing state-of-the-art, loss-optimized fiber-based telecom components, the inventors method can harness secret keys also from measurements performed in the phase basis at reduced losses by ˜6 dB. This would yield a 16-fold enhancement in the photon events extracted from this basis as outlined below. This highlights the potential for designing time-bandwidth product of entangled photon sources in terms of secret key rates and security for untrusted-source QKD.

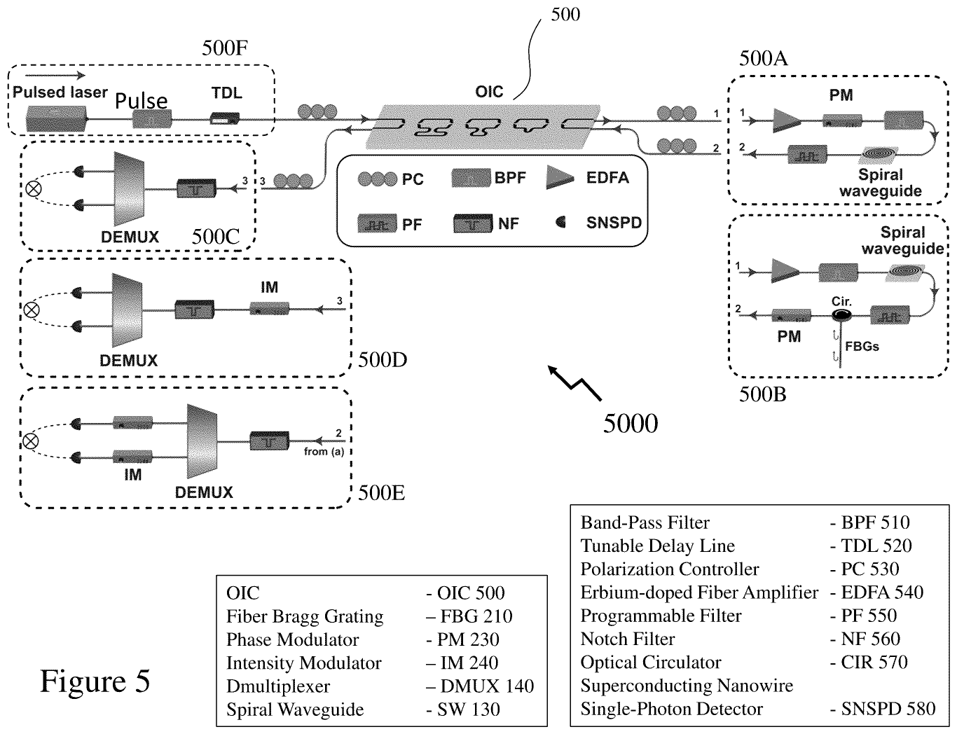

Experimental Set-Up: The experiments described above employed an experimental set as depicted in FIG. 5 by System 5000 for quantum state generation and processing. Within the experiments performed different combinations of the first to fifth Modules 500A to 500E were employed for the measurements. A common optical pulse generator, sixth Module 500F, was employed to provide the pulses to the common OIC 500 comprising a Pulsed Laser, Band-Pass Filter (BPF) 510 and Tunable Delay Line (TDL) 520. The different combinations employed were:
Quantum Interference Measurements (i.e., for 4- and 8-level entangled states)—First Module 500A and fourth Module 500D;
Quantum State Tomography (QST)—Second and third Modules 500B and 500C; and
Joint Temporal Distribution Measurements—First and fifth Modules 500A and 500E.

The OIC 500 in FIG. 5 is optically coupled to the Spiral Waveguide (SW) 130 via an optical fiber interconnection and other optical components.

Within an embodiment of the invention the SW 130 within which the spontaneous four-wave mixing occurs may be a 45 cm high-index doped silica waveguide fabricated on a CMOS-compatible photonic chip.

Within embodiments of the invention the OIC 500 and SW 130 may be integrated into a common platform together with an optical amplifier, e.g., a semiconductor optical amplifier (SOA) and/or optical waveguide amplifier (e.g., erbium-doped silica waveguide), and phase modulator, PM 230. The SOA and PM 230 may be monolithically integrated upon a common substrate with the OIC 500 and SW 130 or one or both may be hybridly integrated with a PIC comprising the OIC 500 and SW 130.

The fiber-coupled OIC 500 employed within the configurations depicted in FIG. 5 exhibited an overall input-to-output loss <4.5 dB. The d-fold pump pulse train was prepared from a mode-locked laser with 250 MHz repetition rate which was spectrally filtered to ˜5ps pulse duration centered at 1,556.15 nm (corresponding to the H26 telecom channel). The generated pulses were amplified with an erbium-doped fiber amplifier (EDFA) and then launched into the spiral waveguide to induce spontaneous four-wave-mixing for the generation of signal and idler photon pairs. Photons were then directed into a programmable filter, an electro-optic phase modulator, and then back into the OIC for quantum state processing.

After coherent mixing of the time modes in the OIC, the photons were separated into two fiber channels using a standard wavelength-division multiplexer. After demultiplexing the signal and idler were directed into the superconducting nanowire single-photon detectors (SNSPDs) which operate around 1,550 nm with 45ps jitter time and 20 ns dead time. The photon coincidences were measured using a Time Interval Analyzer (TIA) and Time-Correlated Single Photon Counting (TCSPC) system. The experimental setup for quantum state processing had a total transmission loss of ˜12.5 dB, which included ˜3 dB for the phase modulator, ˜7.5 dB for the OIC (4.5 dB and 3 dB insertion and splitting losses, respectively), and ˜2 dB for the fiber components.

Quantum Interference Measurements: The coherent mixing of the time modes within the experiments performed by the inventors was realized by propagating the entangled states through the OIC, where the modes experienced splitting, delay, and partial recombination (see FIG. 2B). Arbitrary phase modulation of each time mode was achieved externally through a 40 GHz phase modulator driven by a 62.5 GSa/s arbitrary waveform generator (AWGen). The realized projection measurements were of the form in Equation (4) where θ is the relative phase difference between the neighbouring time modes.

$${{{\vert {Ψ}_{proj} 〉}_{s , i} = \frac{1}{d} ( {\sum }_{k = 0}^{d - 1} {e}^{i {θ}_{k}} \vert k 〉}_{s} ) ( {\sum }_{k = 0}^{d - 1} {e}^{i {θ}_{k}} \vert k 〉}_{i} ) \qquad ( 4 )$$

Four-Level Quantum State Tomography and Logarithmic Negativity: The inventors in order perform the 4-level quantum state tomography employed a frequency-to-time mapping scheme realized with a custom-made fiber Bragg grating (FBG) array featuring an insertion loss <1.5 dB (see FIG. 2B and FIG. 5). This array consisted of two femtosecond-written FBGs matched to the photon wavelengths, namely, 1,559.39 nm and 1,552.93 nm for the signal and the idler, respectively. The FBGs also separated the photons in time for individual phase modulation using a single electro-optic modulator. Full quantum state tomography necessitates 256 measurements resulting from the combination of a set of 16 single-photon projections, which typically require the mixing of three neighbouring modes. However, the design of our OIC allowed us to perform any mode mixing except for three-mode mixing due to a missing active phase control on the MZIs. To address this issue, the inventors considered a problem-specific complete set of 16 single-photon projections that allowed them to measure the full quantum state tomography (QST) without performing three-mode mixing. The projections used are given in Table 1.

From quantum state tomography, the inventors estimated the logarithmic negativity, an entanglement monotone employed to quantify the entanglement of the density matrix ρ of the 4-level photon state. The logarithmic negativity being defined by Equation (5) where Γ is the partial transpose conjugate operation on one photon (e.g., the signal photon), while ∥A∥₁ is given by Equation (6).

$$LN ( ρ ) = {log}_{2} ‖ {ρ}^{Γ} ‖ \qquad ( 5 )$$

$${‖ A ‖}_{1} = tr \sqrt{{A}^{†} A} \qquad ( 6 )$$

TABLE 1
Set of 16 Single-Photon Projections used for QST

| | |
|---|---|
| \|0> | $\frac{1}{2} ( \vert 0 〉 + \vert 1 〉 + \vert 2 〉 + i \vert 3 〉 )$ |
| $\frac{1}{√ 2} ( \vert 0 〉 + \vert 1 〉 )$ | $\frac{1}{2} ( \vert 0 〉 + i \vert 1 〉 - \vert 2 〉 - \vert 3 〉 )$ |
| $\frac{1}{√ 2} ( \vert 2 〉 + \vert 3 〉 )$ | $\frac{1}{2} ( i \vert 0 〉 - i \vert 1 〉 + \vert 2 〉 - \vert 3 〉 )$ |
| \|3> | $\frac{1}{2} ( - \vert 0 〉 + \vert 1 〉 - i \vert 2 〉 + \vert 3 〉 )$ |
| $\frac{1}{√ 2} ( \vert 0 〉 - i \vert 1 〉 )$ | $\frac{1}{2} ( - i \vert 0 〉 + i \vert 1 〉 - i \vert 2 〉 - \vert 3 〉 )$ |
| $\frac{1}{√ 2} ( \vert 2 〉 + i \vert 3 〉 )$ | $\frac{1}{2} ( \vert 0 〉 - i \vert 1 〉 + i \vert 2 〉 + \vert 3 〉 )$ |
| $\frac{1}{2} ( \vert 0 〉 - \vert 1 〉 + \vert 2 〉 - \vert 3 〉 )$ | $\frac{1}{2} ( \vert 0 〉 - i \vert 1 〉 - i \vert 2 〉 + i \vert 3 〉 )$ |
| $\frac{1}{2} ( \vert 0 〉 - i \vert 1 〉 - \vert 2 〉 - i \vert 3 〉 )$ | $\frac{1}{2} ( \vert 0 〉 + \vert 1 〉 - i \vert 2 〉 - i \vert 3 〉 )$ |

The inventors measured a value of 1.5477, which demonstrates that the generated 4-level entangled qudits carry on more that 1 ebit of quantum information. Considering a two-qudit system, maximally entangled states have log₂d ebits that, in the case of d=4 levels, results in log₂(4)=2.

Derivation of 8-Level Bell's Inequality Threshold: The visibility threshold to verify d-level two-partite entanglement can be derived from a linear noise model. According to this, when affected by white noise, the density matrix ρ=|ψ [symbol] [symbol] ψ| of a photon state |ψ [symbol] is modified as given by Equation (7) where λ_{d} is the probability that the quantum state is not affected by noise and I is the identity matrix. An 8-level entangled state can tolerate a critical noise mixture of λ_{8,thr}=31.8% prior to losing entanglement. From this value, it is possible to derive the visibility threshold through the expression given by Equation (8) such that, for the 8-level case, V₈=89.56%.

$${ρ}^{′} = {λ}_{d} \vert ψ 〉 〈 ψ \vert + ( 1 - {λ}_{d} ) \frac{𝕀}{{d}^{2}} \qquad ( 7 )$$

$${V}_{d} = \frac{d {λ}_{d}}{2 + {λ}_{d} ( d - 2 )} \qquad ( 8 )$$

Untrusted-Source [symbol] KD based on 4-level Entangled Photons: High-dimensional QKD protocols rely on two sets of mutually unbiased bases—the time and the phase bases—which are randomly chosen by the recipients, e.g. Alice and Bob, to perform measurements, thus to establish secret keys. When Alice and Bob randomly select the same basis, their measurements lead to correlated outcomes, which give rise to the sifted secret key. Uncorrelated data resulting from measurements performed in different bases are discarded in the so-called sifting procedure. At the same time, Alice and Bob monitor the quantum bit error rate (QBER). This method ensures that any attempt by an eavesdropper to intercept the key by measuring its carrier (i.e., the photon) can be detected by the trusted parties.

In the case of d-level systems, among all possible outcomes, there is only one correct event and d−1 error events. A random event corresponding to the correct outcome occurs with a probability given by Equation (9) where (1-λ_{d})/d is the probability of an error outcome, namely, Pₑᵣᵣ. From this, it is possible to derive the QBER, which is given by Equation (10). Such a relation allows deriving the QBER directly from quantum interference measurements and visibility values. From 4-level quantum interference, we measured a visibility of 90.14% and thus a λd=82.05%. From this λd value, we estimated a phase basis error of 13.46%, which matched our QKD results.

$${P}_{corr} = {λ}_{d} + \frac{1 - {λ}_{d}}{d} \qquad ( 9 )$$

$$e = ( d - 1 ) {P}_{err} = {λ}_{d} + \frac{( ( d - 1 ) ) ( 1 - {λ}_{d} )}{d} \qquad ( 10 )$$

$$\vert {f}_{n} 〉 = \frac{1}{\sqrt{d}} {\sum }_{k = 0}^{d - 1} {e}^{i \frac{2 π}{d} \cdot k \cdot n} \vert k 〉 \qquad ( 11 )$$

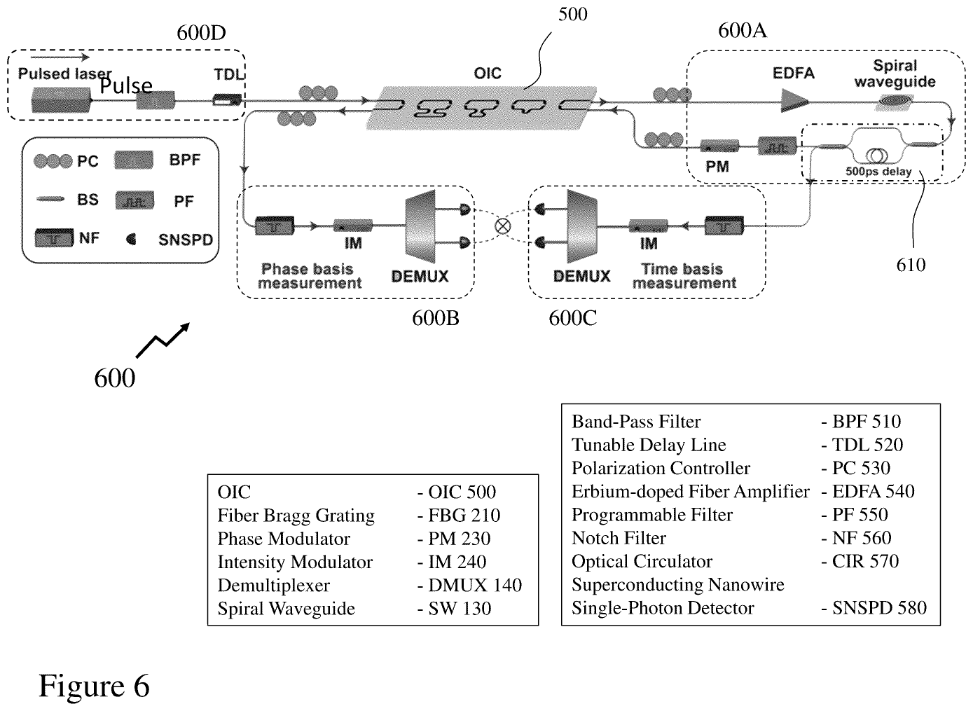

The two mutually unbiased bases are the time basis {|k [symbol] } (with k=0,1,2,3) and the phase basis {|n [symbol] }, are given by the superposition |fn [symbol] in Equation (11) with n=0,1,2,3. Within the experiments performed by the inventors the photons were randomly directed to either the time- or the phase-measurement using a beam splitter-based delay scheme as depicted in FIG. 6 with Measurement System 600 wherein an Optical Pulse Generator 600D, e.g., sixth Module 500F as described in FIG. 5, is coupled to the OIC 500 and therein to an Optical Loop 600A comprising EDFA 540, SW 130, Passive Delay Module (PDM) 610, Programmable Filter 550 and Phase Modulator 230. The PDM 610 comprising a passive splitter, two parallel arms with defined time delay different (e.g., 500 ps as depicted), and a coupler. As depicted one output of the coupler within PDM 610 is fed back to the OIC 500 whilst the other is coupled to Time Basis Measurement Module 600C. The optical output of the coupler within PDM 610 fed back to the OIC 500 is subsequently coupled to Phase Basis Measurement Module 600B via an initial 2×2 element within OIC 500 coupled to the optical pulse generator rather than a 1×2 element as described with respect to FIG. 1A.

The Measurement System 600 allows photons to randomly arrive to the respective measurement modules, Phase Basis Measurement Module 600B and Time Basis Measurement Module 600C, either at the same time or with the temporal delay within the. This time delay within experiments were set to 500 ps, equivalent to 1 GHz frequency offset, as this corresponds to twice the repetition rate of the pulsed laser employed within the measurements within the Optical Pulse Generator 600D. Measurements in the time basis, with Time Basis Measurement Module 600C, were realized by applying an external temporal filtering to the received photons, which was accomplished by making use of an electro-optic intensity modulator (IM 240) driven by a 62.5GSa/s AWGen. Measurements in the phase basis, with the Phase Basis Measurement Module 600B, were performed using an electro-optic phase modulation, via PM 230, followed by temporal filtering. This setup had an additional transmission loss of approximately 17.5 dB, arising from the programmable filter (PF 550, approximately 5 dB), the phase modulator (PM 230, approximately 3 dB), the OIC (OIC 500, approximately 7.5 dB), and the other fiber components (approximately 2 dB). It would be evident that employing lower loss components as well as removing the programmable filter (PF 550, currently used for system optimization), the total losses could be reduced, by approximately 6 dB.

The secret key rate (SKR) was calculated through the expression given by Equation (12) where r_{sift} is the sifted key rate, eₜ(e_{f}) is the measured QBER of time (phase) basis, f(x) is the error correction efficiency as a function of error rate (the inventors set this as f(x)=1.2 within the results presented), and H_{d}(x)Hd(x) is the d-dimensional Shannon entropy function given by Equation (13).

$$S K R \geq {r}_{sift} [ {log}_{2} d - f ( {e}_{t} ) {H}_{d} ( {e}_{t} ) - {H}_{d} ( {e}_{f} ) ] \qquad ( 12 )$$

$${H}_{d} ( x ) = - x {log}_{2} ( \frac{x}{d - 1} ) - ( 1 - x ) {log}_{2} ( 1 - x ) \qquad ( 13 )$$

As described above in respect of embodiments of the invention a photonic platform comprising an on-chip interferometer cascade (OIC) comprising a switchable cascade of unbalanced Mach-Zehnder interferometers (MZIs) and optical time delays is employed in conjunction with a spiral waveguide (e.g. SW 130) to generate the signal and idler photonic qudits.

Within FIG. 1A the SW 130 is depicted integrated within the OIC 100 with the switchable cascade and time delays whereas within FIG. 2A the OIC 100 is depicted with the SW discrete from the switchable cascade and time delays whilst within FIGS. 2B and 2C the OIC 100 is depicted with the SW omitted for clarity. Within FIG. 4A the OIC is depicted absent the SW as it is within FIGS. 5 and 6 with OIC 500. As noted above the SW may be monolithically integrated with the switchable cascade and time delays together with other optical elements such as optical amplifier(s) etc. or it within other embodiments of the invention be hybridly interconnected or interconnected via an optical fiber, photonic wirebond etc.

Now referring to FIG. 7 there is depicted a schematic of a PIC 700 upon which an on-chip interferometer cascade (OIC) is formed such as forms part of the photonic platform according to the embodiment of the invention such as OIC 100 or OIC 500 for example. As depicted PIC 700 comprises a linear cascade of first to ninth 2×2 Optical Switches 710A to 710I respectively, an output 2×2 Switch 730, a Controller 740 and first to eighth Waveguide Stages 720A to 720H respectively.

Each of the first to eighth Waveguide Stages 720A to 720H respectively comprises a pair of waveguides. One waveguide of the pair of waveguides is coupled from an output of a preceding optical switch of the linear cascade of first to ninth 2×2 Optical Switches 710A to 7101 respectively to an input of a subsequent optical switch of the linear cascade of first to ninth 2×2 Optical Switches 710A to 7101 respectively. The other waveguide of the pair of waveguides is coupled from the other output of the preceding optical switch of the linear cascade of first to ninth 2×2 Optical Switches 710A to 710I respectively to the other input of the subsequent optical switch of the linear cascade of first to ninth 2×2 Optical Switches 710A to 7101 respectively. The waveguide of the pair of waveguides has an increased optical path length between the preceding optical switch of the linear cascade of first to ninth 2×2 Optical Switches 710A to 710I respectively to the other input of the subsequent optical switch of the linear cascade of first to ninth 2×2 Optical Switches 710A to 710I respectively relative to that of the other waveguide of the pair of waveguides such that the optical signals when coupled into the waveguide of the pair of waveguides are delayed by a defined delay relative to when they are coupled to the waveguide of the pair of waveguides. This path length and resulting delay doubles for each Waveguide Stage of the first to eighth Waveguide Stages 720A to 720H respectively such that the first Waveguide Stage 720A provides a delay of 1t via its waveguide of the pair of waveguides, the second Waveguide Stage 720B a delay of 2t via its waveguide of the pair of waveguides, the third Waveguide Stage 720C a delay of 4t via its waveguide of the pair of waveguides, etc. until the penultimate and final Waveguide Stages 720G and 720H provide delays of 64t and 128t via their waveguides of the pair of waveguides.

Within PIC 700 the delay in the penultimate Waveguide Stage 720G is 128t whilst the final Waveguide Stage 720H provides delay of 64t. The actual sequence of the delays can be defined by factors such as layout of the PIC 700 etc. provide that all the requisite delays are implemented within the series of waveguide stages. Accordingly, the PIC 700 as depicted provides for delays from 1t to 256t, i.e. 1 ps to 256ps if t=1 ps, for a system according to an embodiment of the invention supporting 8-level entangled photon states. It would be evident that variants of PIC 700 may be implemented with N stages for N-level entangled photon states where N≥2.

The output 2×2 Switch 730 is coupled to an output of the ninth 2×2 Optical Switch 710I to provide PIC 700 output ports “Out2a” and “Out2b” whilst the other output of the ninth 2×2 Optical Switch 710I provides the other output port “Out1.” The input ports of the first 2×2 Optical Switch 701A are coupled to the PIC 700 input ports “In1” and “In2.” Each of the first to ninth 2×2 Optical Switches 710A to 7101 and Output Switch 730 are electrically connected to the Controller 740 which provides the requisite control signals, and if necessary biasing signals, to each to put them into the require state. As noted above each of the first to ninth 2×2 Optical Switches 710A to 7101 and 2×2 Switch 730 may be a Mach-Zehnder Interferometer (MZI), a directional coupler, a zero gap directional coupler and a multimode interferometer for example.

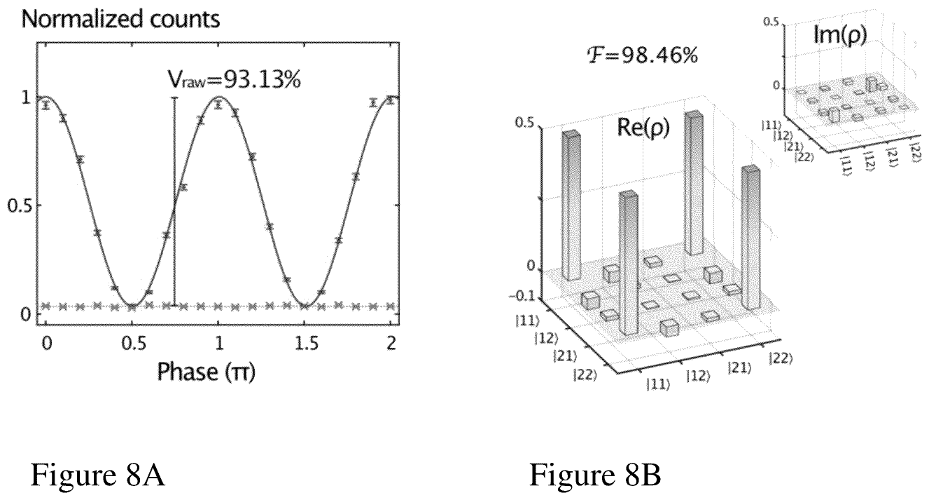

As noted above the inventors in addition to performing experiments with the inventive photonic platform to provide 4-level and 8-level entangled photon pairs also performed entanglement validation with 2-level photon pairs. Referring to FIG. 8A there is depicted the measured quantum interference using channel H22-H30, from which the inventors extracted a raw visibility of 93.13%, which increases to 99.98% after background noise subtraction. Both values exceed the 71% threshold necessary to violate Bell's inequality. The corresponding 4-level and 8-level quantum interference being presented in FIGS. 3A and 3B. FIG. 8B presents the density matrix retrieved from quantum state tomography for the 2-level entangled states, FIG. 3C depicting the density matrix for the 4-level entangled states. The estimated fidelity of 98.46% for the 2-level entangled states shows a good agreement between the ideal and the measured entangled states.

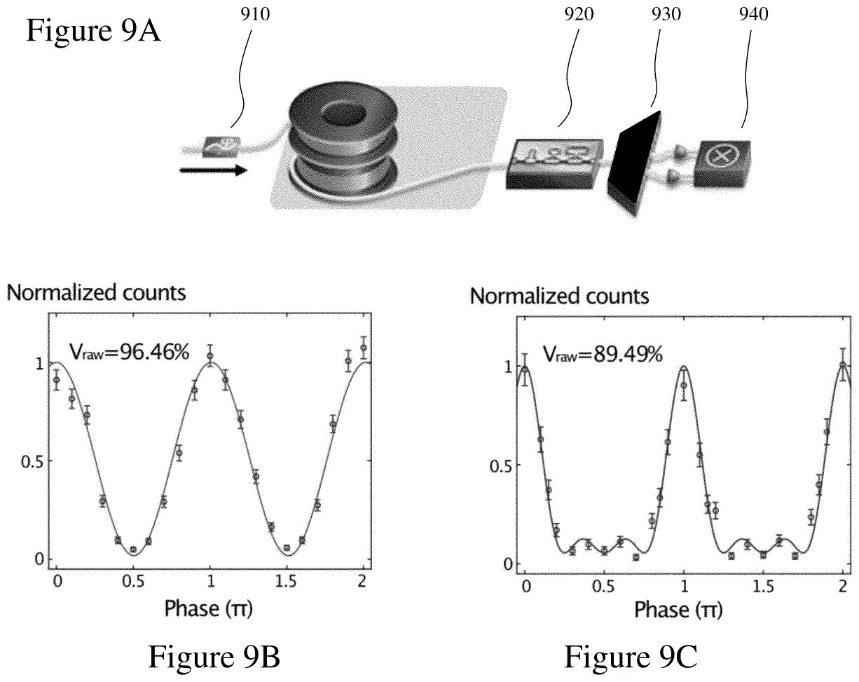

Referring to FIG. 9A the experimental set up for mimicking 2 users separated by 60 km as discussed and described above is depicted wherein the signal and idler photons each propagate over 20 km of standard single-mode fiber (SMF) and 10 km of dispersion-compensating fiber (DCF) from a Phase Modulator 910 to the on-chip interferometer cascade (OIC) 920 and therein Demultiplexer 930 to Receiver 940. The experiment setup was also used for quantum interference measurements after photon propagation. The position of the phase modulator (PM*) is indicated in the setup for completeness. Referring to FIGS. 9B and 9C there are depicted the measured quantum interferences for 2-level and 4-level entangled photon pairs, respectively, over the experimental set-up depicted in FIG. 9A.

Within the following sections supplementary notes are presented with respect to the time entanglement from the on-chip interferometer cascade (OIC) and four-wave mixing within the spiral waveguide (SW), the underlying d-level source-independent quantum key distribution (QKD), quantum state propagation and a comparison of the inventive photonic platform performance relative to the prior art.

### Time Entanglement Via Interferometer Cascade and Spontaneous Four-Wave Mixing

The on-chip interferometer cascade (OIC) employed within an embodiment of the inventive photonic platform consists of a fully connected concatenation of balanced and unbalanced Mach-Zehnder interferometers (MZIs), see FIG. 7 for example. The transmission matrix for a single 50:50 coupler is given by Equation (14). The transmission matrix for all j balanced MZIs, considering the relative phase between two arms Δψj, can be expressed by Equation (15) where j=1,2, . . . , 10 (see FIG. 7). The output splitting ratio of each MZI can be tuned by controlling by changing the relative phases Δψj, for example the voltage of electric heaters on top of the waveguides within silica implementations although within other waveguide systems other effects such as electro-optic effects, Kerr effect, current injection etc. are employed or current injection. Within the work reported above the inventors employed only three states of the MZIs (splitting ratios), that is, full transmission (t), full reflection (r), and 50:50 splitting, which correspond to the relative phases Δψⱼ=0, Δψⱼ=π and Δψⱼ=π/2, respectively. This way, the transmission matrix \hat{T}_{MZI}^{(j)} reduces to the forms of Equations (16A) to (16C) respectively.

$${\hat{T}}_{50 : 50} = \frac{1}{\sqrt{2}} ( \begin{matrix}1 & i \\ i & 1\end{matrix} ) \qquad ( 14 )$$

$${\hat{T}}_{MZI}^{( i )} = {\hat{T}}_{50 : 50} ( \begin{matrix}{e}^{i {Δψ}_{j}} & 0 \\ 0 & 1\end{matrix} ) {\hat{T}}_{50 : 50} = \frac{1}{2} ( \begin{matrix}{e}^{i {Δψ}_{j}} - 1 & {ie}^{i {Δψ}_{j}} + i \\ {ie}^{i {Δψ}_{j}} + i & 1 - {e}^{i {Δψ}_{j}}\end{matrix} ) , \qquad ( 15 )$$

$${\hat{T}}_{MZI}^{( t )} = ( \begin{matrix}0 & i \\ i & 0\end{matrix} ) \qquad ( 16 A )$$

$${\hat{T}}_{MZI}^{( r )} = ( \begin{matrix}- 1 & 0 \\ 0 & 1\end{matrix} ) \qquad ( 16 B )$$

$${\hat{T}}_{MZI}^{( 50 : 50 )} = \frac{1}{2} ( \begin{matrix}i - 1 & i - 1 \\ i - 1 & 1 - i\end{matrix} ) \to \frac{1}{2} ( \begin{matrix}1 & 1 \\ 1 & - 1\end{matrix} ) \qquad ( 16 C )$$

The unbalanced MZIs have a relative path delay that incrementally doubles (e.g., from 1 ps, to 2 ps, to 4 ps, up to 128 ps within the exemplary embodiment employed in the demonstrations), thus allowing for pulse shaping on time scales beyond the capabilities of current spectral wave-shaping technologies. After one delay of the unbalanced MZI, an input optical pulse is split to obtain two pulses at the output. If the coherence time of the pulse is shorter than the temporal delay between the MZIs, we can assume that there is no temporal overlap between the created pulses after they experience splitting, delaying, and recombination.

We give the mathematical formalism describing the processing of the generated photonic time modes through our OIC. In general, a time mode going through a short path remains unchanged, while a time mode going through the long path experiences a temporal shift. Here, we define the shift operator Ŝₘ for an m^{th}-step time shift as Equation (17) where âₖ^{†} denotes the creation operator in the mode k, while |vac [symbol] is the vacuum state.

$${\hat{S}}_{m} {\hat{a}}_{k}^{†} \vert vac 〉 = {\hat{a}}_{k + m}^{†} \vert vac 〉 \qquad ( 17 )$$

As an example of this formalism, we consider the preparation of 4-level entangled qudits. In this case, we activated two unbalanced MZIs having arm differences of 128 ps and 64 ps, whose delay is represented by the shift operators Ŝ₂ and Ŝ₁, respectively. Such a configuration gives rise to a time mode spacing of 64 ps. The time-mode shift operation and the additional phase difference (Δφₙ^{(†)} given by the two different MZIs' paths result in the delay transmission matrices defined by Equations (18A) and (18B) respectively.

$${\hat{T}}_{128 p s}^{( delay )} = ( \begin{matrix}{\hat{S}}_{2} {e}^{i {Δφ}_{1}} & 0 \\ 0 & {e}^{i {Δφ}_{1}^{′}}\end{matrix} ) \qquad ( 18 A )$$

$${\hat{T}}_{64 p s}^{( delay )} = ( \begin{matrix}{\hat{S}}_{1} {e}^{i {Δφ}_{2}} & 0 \\ 0 & {e}^{i {Δφ}_{2}^{′}}\end{matrix} ) \qquad ( 18 B )$$

Setting the seventh to ninth 2×2 Optical Switches 710(G) to 710(I) within PIC 700 in FIGS. 7 and 8, and 9 to 50:50 and the other first to sixth 2×2 Optical Switches 710(A) to 710(F) to either full transmission or full reflection, the single time mode \hat{α}₀^{†}|vac [symbol] entering the input port 2 (In2) experiences a splitting that is given by Equation (19A).

$${\hat{T}}_{MZI}^{( 50 : 50 )} {\hat{T}}_{64 p s}^{( delay )} {\hat{T}}_{MZI}^{( 50 : 50 )} {\hat{T}}_{128 p s}^{( delay )} {\hat{T}}_{MZI}^{( 50 : 50 )} ( \begin{matrix}0 \\ {\hat{a}}_{0}^{†} \vert vac 〉\end{matrix} ) \to \frac{1}{2} ( \begin{matrix}\{ {e}^{i ( {Δφ}_{1} + {Δφ}_{2} )} {\hat{a}}_{3}^{†} + {e}^{i ( {Δφ}_{1} + {Δφ}_{2}^{′} )} {\hat{a}}_{2}^{†} - {e}^{i ( {Δφ}_{2} + {Δφ}_{1}^{′} )} {\hat{a}}_{1}^{†} + {e}^{i ( {Δφ}_{1}^{′} + {Δφ}_{2}^{′} )} {\hat{a}}_{0}^{†} \} \vert vac 〉 \\ \{ {e}^{i ( {Δφ}_{1} + {Δφ}_{2} )} {\hat{a}}_{3}^{†} - {e}^{i ( {Δφ}_{1} + {Δφ}_{2}^{′} )} {\hat{a}}_{2}^{†} - {e}^{i ( {Δφ}_{2} + {Δφ}_{1}^{′} )} {\hat{a}}_{1}^{†} - {e}^{i ( {Δφ}_{1}^{′} + {Δφ}_{2}^{′} )} {\hat{a}}_{0}^{†} \} \vert vac 〉\end{matrix} ) \qquad ( 19 A )$$

$$\vert {Ψ}_{1} 〉 = \frac{1}{2} ( {e}^{i ( {Δφ}_{1} + {Δφ}_{2} )} {\hat{a}}_{3}^{†} + {e}^{i ( {Δφ}_{1} + {Δφ}_{2}^{′} )} {\hat{a}}_{2}^{†} - {e}^{i ( {Δφ}_{2} + {Δφ}_{1}^{′} )} {\hat{a}}_{1}^{†} + {e}^{i ( {Δφ}_{1}^{′} + {Δφ}_{2}^{′} )} {\hat{a}}_{0}^{†} ) \vert vac 〉 \qquad ( 20 A )$$

$$\vert {Ψ}_{2} 〉 = \frac{1}{2} ( {e}^{i ( {Δφ}_{1} + {Δφ}_{2} )} {\hat{a}}_{3}^{†} - {e}^{i ( {Δφ}_{1} + {Δφ}_{2}^{′} )} {\hat{a}}_{2}^{†} - {e}^{i ( {Δφ}_{2} + {Δφ}_{1}^{′} )} {\hat{a}}_{1}^{†} - {e}^{i ( {Δφ}_{1}^{′} + {Δφ}_{2}^{′} )} {\hat{a}}_{0}^{†} ) \vert vac 〉 \qquad ( 20 B )$$

Here, the inventors have neglected the additional global phase given by other switches and delays. The output states from ports Out1 and Out2a are thus given by Equations (20A) and (20B) respectively. The state |Ψ1 [symbol] from port Out1 is taken to prepare time-entanglement (i.e., following optical amplification and injection into the spiral), while the state |Ψ2 [symbol] from port Out2a is blocked. Port Out2a is thereafter used to send the generated signal and idler photons back to the same OIC for quantum state processing. The state vector representing the signal/idler photons entering port Out2a can be expressed as Equation (21) whilst the processed output is given by Equation (22).

$$( \begin{matrix}0 \\ \frac{1}{2} \{ {e}^{i ( {Δφ}_{1} + {Δφ}_{2} )} {\hat{a}}_{3}^{†} + {e}^{i ( {Δφ}_{1} + {Δφ}_{2}^{′} )} {\hat{a}}_{2}^{†} - {e}^{i ( {Δφ}_{2} + {Δφ}_{1}^{′} )} {\hat{a}}_{1}^{†} + {e}^{i ( {Δφ}_{1}^{′} + {Δφ}_{2}^{′} )} {\hat{a}}_{0}^{†} \} \vert vac 〉\end{matrix} ) \qquad ( 21 )$$

$${\hat{T}}_{MZI}^{( 50 : 50 )} {\hat{T}}_{128 p s}^{( delay )} {\hat{T}}_{MZI}^{( 50 : 50 )} {\hat{T}}_{64 p s}^{( delay )} {\hat{T}}_{MZI}^{( 50 : 50 )} ( \begin{matrix}0 \\ \frac{1}{2} \{ {e}^{i ( {Δφ}_{1} + {Δφ}_{2} )} {\hat{a}}_{3}^{†} + {e}^{i ( {Δφ}_{1} + {Δφ}_{2}^{′} )} {\hat{a}}_{2}^{†} - {e}^{i ( {Δφ}_{2} + {Δφ}_{1}^{′} )} {\hat{a}}_{1}^{†} + {e}^{i ( {Δφ}_{1}^{′} + {Δφ}_{2}^{′} )} {\hat{a}}_{0}^{†} \} \vert vac 〉\end{matrix} ) \qquad ( 22 )$$

$$\frac{1}{2} {e}^{i ( {Δφ}_{1} + {Δφ}_{2} + {Δφ}_{1}^{′} + {Δφ}_{2}^{′} )} \{ {\hat{a}}_{3 + 0}^{†} + {\hat{a}}_{2 + 1}^{†} + {\hat{a}}_{1 + 2}^{†} + {\hat{a}}_{0 + 3}^{†} \} \vert vac 〉 \qquad ( 23 )$$

This will result in seven time-modes (see FIG. 2B). The center time-mode (corresponding to \hat{α}₃^{†} is the superposition of the generated 4-level entangled state as given by Equation (23) and can be retrieved from port In1. The indices j and k in \hat{α}ⱼ₊ₖ^{†} represent the forward and the backward propagation delay, respectively. The global phase factor e^{i(Δφ1+Δφ2+Δφ′1+Δφ′2)} indicates that, during forward and backward propagation, all the time modes in \hat{α}₃^{†} propagate over the same path-meaning that they experience both the 64 ps and the 128 ps delay only once. This compensates the arbitrary phase offset per delay for a bias-free interference. However, in the case of three-mode mixing (i.e., the interference modes \hat{α}₂^{†} and \hat{α}₃^{†}), the forward and backward propagations follow different paths. For instance, for those time modes overlapping at \hat{α}₂^{†}, some of them go through the 64 ps delay twice, while others go through the 128 ps delay once. This leads to additional phase issues, meaning that the modes interfering in \hat{α}₂^{†} and \hat{α}₄^{†} are not in a defined relative phase. This issue prevented the inventors from performing quantum interference measurements based on three mode-mixing.

### D-Level Untrusted-Source Quantum Key Distribution (QKD)

In the proof-of-principle experiment of d-level source-independent quantum key distribution (QKD), the inventors first generated the photon pairs and then routed them into a beam splitter-based delay scheme, where the signal and idler photons went through either the short or the long path (as shown in FIG. 6). The two-photon state after the delay scheme reads as Equation (24) where |S [symbol] ₛ₍ᵢ₎ and |L [symbol] ₛ₍ᵢ₎ denote the short and the long path traveled by the signal (idler) photon, respectively. The two photons were then randomly routed to either the time or the phase basis measurement system. The two-photon state experiencing the time and phase basis measurement scheme then reads as Equation (25).

$${{{{{{{{\vert Φ 〉 = \frac{1}{2} ( \vert S 〉}_{s} \vert S 〉}_{i} + \vert S 〉}_{s} \vert L 〉}_{i} + \vert L 〉}_{s} \vert S 〉}_{i} + \vert L 〉}_{s} \vert L 〉}_{i} ) \qquad ( 24 )$$

$${{{{{{{{{{{{{{{{{{{{{{{{{{{{{{{{\vert {Φ}^{′} 〉 = \frac{1}{4} ( \vert S , t 〉}_{s} \vert S , t 〉}_{i} + \vert S , t 〉}_{s} \vert S , p 〉}_{i} + \vert S , p 〉}_{s} \vert S , t 〉}_{i} + \vert S , p 〉}_{s} \vert S , p 〉}_{i} + \vert S , t 〉}_{s} \vert L , t 〉}_{i} + \vert S , t 〉}_{s} \vert L , p 〉}_{i} + \vert S , p 〉}_{s} \vert L , t 〉}_{i} + \vert S , p 〉}_{s} \vert L , p 〉}_{i +} + \vert L , t 〉}_{s} \vert S , t 〉}_{i} + \vert L , t 〉}_{s} \vert S , p 〉}_{i} + \vert L , p 〉}_{s} \vert S , t 〉}_{i} + \vert L , p 〉}_{s} \vert S , p 〉}_{i} + \vert L , t 〉}_{s} \vert L , t 〉}_{i} + \vert L , t 〉}_{s} \vert L , p 〉}_{i} + \vert L , p 〉}_{s} \vert L , t 〉}_{i} + \vert L , p 〉}_{s} \vert L , p 〉}_{i} ) \qquad ( 25 )$$

Here, |S,t [symbol] ₛ₍ᵢ₎ denotes the signal (idler) photon traveling the short path S and subsequentially being routed into the time t basis; |S, p [symbol] ₛ₍ᵢ₎ (denotes the signal (idler) photon traveling the short path S and subsequentially being routed into the phase p basis; similarly, |L, t [symbol] ₛ₍ᵢ₎ denotes the signal (idler) photon traveling the long path L and subsequentially being routed into the time t basis, while |L, p [symbol] ₛ₍ᵢ₎ denotes the signal (idler) photon traveling the long path L and subsequentially being routed into the phase p basis. In this work, the inventors considered the cases where both signal and idler went to the same measurement basis, while the other half of the cases were discarded.

4-Level [symbol] KD Implementation

For 4-level QKD, the 64 ps spacing of time modes almost approaches the jitter time of the superconducting nanowire single-photon detectors (SNSPDs) used in the experiment (i.e., 45 ps). While such a jitter time can still resolve the 4-level qudits, it brings however a higher crosstalk from adjacent time modes, which increases the quantum bit error rate (QBER). To address this issue, in the time basis measurement system, we implemented an external temporal filtering that only selects time modes |0 [symbol] and |2 [symbol] for the short path of the beam splitter-based delay scheme, and only time modes |1 [symbol] and |3 [symbol] for the long path. This is described by Equations (25A) and 25B) where the measurement operator of the time basis is given by Equation (26).

$${{\vert S , t 〉}_{s ( i )} \to \frac{1}{\sqrt{2}} ( \vert 0 〉 + \vert 2 〉 )}_{s ( i )} \qquad ( 25 A )$$

$${{\vert L , t 〉}_{s ( i )} \to \frac{1}{\sqrt{2}} ( \vert 1 〉 + \vert 3 〉 )}_{s ( i )} \qquad ( 25 B )$$

$$\hat{{M}_{t}} = \frac{1}{2} ( \vert {0}_{s} {0}_{i} 〉 〈 {0}_{s} {0}_{i} \vert + \vert {1}_{s} {1}_{i} 〉 〈 {1}_{s} {1}_{i} \vert + \vert {2}_{s} {2}_{i} 〉 〈 {2}_{s} {2}_{i} \vert + \vert {3}_{s} {3}_{i} 〉 〈 {3}_{s} {3}_{i} \vert ) \qquad ( 26 )$$

This was realized by temporally post-selecting photon events with a 25% efficiency (i.e., 6 dB loss). The loss of the external temporal filtering system (i.e., the intensity modulator) was 5 dB for each photon. Considering the signal and the idler photons in coincidence, the overall efficiency of the external filtering system is 2.51% (i.e., 16 dB loss). If using SNSPDs with lower jitter time47, the external temporal filtering system can be removed, which leads to an enhancement of the time basis measurement by 16 dB. This results in Equation (27).

Similarly, in the phase basis measurement setting, we applied external phase modulation to project the signal and idler photons into different phase vectors. Then we used the external temporal filtering to select the superposition state given by Equation (28) which results in Equation (29) The measurement operator of the phase basis is given by Equation (30). This was realized by temporally post-selecting photon events with 12.5% efficiency.

$${{\vert S ( L ) , t 〉}_{s ( i )} \to \frac{1}{\sqrt{2}} ( \vert 0 〉 + \vert 1 〉 + \vert 2 〉 + \vert 3 〉 )}_{s ( i )} \qquad ( 27 )$$

$$\vert {f}_{n} 〉 = \frac{1}{\sqrt{d}} {\sum }_{k = 0}^{d - 1} {e}^{i \frac{2 π}{d} k \cdot n} \vert k 〉 \qquad ( 28 )$$

$${{\vert S ( L ) , p 〉}_{s ( i )} \to \frac{1}{2} ( \vert {f}_{0} 〉 + \vert {f}_{1} 〉 + \vert {f}_{2} 〉 + \vert {f}_{3} 〉 )}_{s ( i )} \qquad ( 29 )$$

$$\hat{{M}_{p}} = \frac{1}{2} ( \vert {f}_{{0}_{s}} {f}_{{0}_{i}} 〉 〈 {f}_{{0}_{s}} {f}_{{0}_{i}} \vert + \vert {f}_{{1}_{s}} {f}_{{3}_{i}} 〉 〈 {f}_{{1}_{s}} {f}_{{3}_{i}} \vert + \vert {f}_{{2}_{s}} {f}_{{2}_{i}} 〉 〈 {f}_{{2}_{s}} {f}_{{2}_{i}} \vert + \vert {f}_{{3}_{s}} {f}_{{1}_{i}} 〉 〈 {f}_{{3}_{s}} {f}_{{1}_{i}} \vert ) \qquad ( 30 )$$

### 2-Level QKD Implementation

We also implemented 2-level source-independent QKD (i.e., the BBM92 protocol58) to compare the performance of our system with current implementations. The two mutually unbiased bases for qubits are the time basis {|0 [symbol] ,|1 [symbol] } and the phase basis given by Equation (31). In this case, the inventors generated 2-level photon pairs featuring a time mode spacing of 128 ps, which was not affected by the jitter time of the SNSPDs. We measured a raw visibility of 93.13%, which, after background noise subtraction, becomes 99.98% (see FIG. S4).

$$\{ \vert {f}_{0} 〉 = \frac{1}{\sqrt{2}} ( \vert 0 〉 + \vert 1 〉 ) , \vert {f}_{1} 〉 = \frac{1}{\sqrt{2}} ( \vert 0 〉 - \vert 1 〉 ) \} \qquad ( 31 )$$

$${{\vert S , t 〉}_{s ( i )} \to \vert 0 〉}_{s ( i )} \qquad ( 32 A )$$

$${{\vert L , t 〉}_{s ( i )} \to \vert 1 〉}_{s ( i )} \qquad ( 32 B )$$

To make a fair comparison between 2-level and 4-level QKD schemes, the inventors applied the external temporal filtering for the former as well. Such a filtering only selected the time mode |0 [symbol] for the short path of the beam splitter-based delay scheme and the time mode |1 [symbol] for the long path. This is described by Equations (32A) and 32 (B) respectively. Therefore, the time basis measurement events were temporally post-selected by the photon events with a 25% efficiency, which means that the overall efficiency of the external temporal filtering system is the same as the 4-level case, that is, 2.51%. In the phase basis measurement setting, we used external phase modulation for photon state projections and external temporal filtering to select the superposition states given by Equation (31).

The implementation of 2-level QKD without the external temporal filtering led to an enhancement of secret key rates by a value of 40.84 with respect to the case with the external temporal filtering (see FIG. 4D). This result is in agreement with the estimated 2.51% efficiency of the external temporal filtering. It also confirmed that the optimized realization of our 4-level untrusted-source QKD can be implemented by using SNSPDs with lower jitter times (e.g., <20 ps).

### Quantum State Propagation

The inventors have demonstrated the applicability of their inventive photonic platform for QKD for long-distance quantum secure communications by verifying time-entanglement over a 60 km-long fiber link. Such a system consisted of signal and idler photons each propagating through a 30 km-long fiber system, comprising a 20 km-long single-mode fiber (SMF, 4.5 dB loss, 380 ps·nm) and a 10 km-long dispersion-compensating fiber (DCF, 2.9 dB loss, −366 ps·nm). The ultrafast (large-bandwidth) nature of the time modes led to considerable dispersive broadening upon propagation through the SMF, thus causing a mixing of the modes and hence ambiguous post-selection of time-resolved coincidences. The dispersion experienced by the time modes could be compensated after propagation through a DCF module disposed prior to the receiver(s). The experimental results of prototype demonstrators indicate that standard telecommunication systems can support the transmission of the ultrafast time-entangled states demonstrated herein.

The inventors first realized long-distance Bell's inequality test (i.e., quantum interference) by sending the entangled photon pairs through the fiber link. The measured quantum interferences maintained visibilities above Bell's inequality thresholds (see FIGS. 9B and 9C), indicating well-preserved entanglement after realistic fiber-optic communication distances. The inventors further used this fiber system to implement untrusted-source QKD, the results of which fit well with the simulations (see FIGS. 8A and 8B).

### Inventive Photonic Platform Performance Relative to the Prior Art.

The secret key rates of the proposed innovative photonic platform demonstrate a significant increase with respect to current QKD demonstrations based on entangled photons. In Table 2, the inventors present such a comparison. It is also worth noting that the dimensionality of previous realizations is restricted to d=2, while the inventors reported the first proof-of-concept untrusted-source QKD based on entangled qudits (d=4). The inventors' approach and results led to an increase in the number of encoded bits per photon while guaranteeing a higher QBER tolerance.

TABLE 2
Comparison of Invention with Prior Art

| | | | | SKR | | |
|---|---|---|---|---|---|---|
| | Platform | DoF | d | (kbit/s) | QBER | L (km) |
| Appas | AlGaAs | Polarization | 2 | ~0.0010 | ~2% | 50 |
| | waveguide | | | | | |
| Fitzke | PPLN crystal | Time-bin | 2 | 0.0063 | 4.5% | 108 |
| Schimpf | GaAs | Polarization | 2 | 0.086 | 1.9% | 0.35 |
| | quantum dot | | | | | |
| Shi | PPKTP crystal | Polarization | 2 | 0.109 | 6.4% | 10 |
| Wen | SiN photonic | Energy-time | 2 | 0.205 | 3.08% | — |
| | integrated chip | | | | | |
| Neumann | PPLN crystal | Polarization | 2 | 0.2283 | — | 6.46 |
| Ecker | PPKTP crystal | Polarization | 2 | 0.30 | 6.84% | 143 |
| Mishra | PPKTP crystal | Polarization | 2 | 1.71 | 4.50% | 0.2 |
| | High-doped | | 2 | 1.10 | 6.51% | 60 |
| | silica | | | | | |
| Our work | glass photonic | Time-bin | 4 | 2.47* | 11.98% | — |
| | chip | | 4 | 0.042** | 11.29% | 60 |

Note:
DoF: degree of freedom; d: dimension; SKR: secret key rate; QBER: quantum bit error rate; L: communication channel length; AlGaAs: aluminium gallium arsenide; PPLN: periodically poled lithium niobate; GaAs: gallium arsenide; PPKTP: periodically poled potassium titanyl phosphate; SiN: silicon nitride.
Note:
*potentially improvable to 100.9 kbits/s without considering the external temporal filtering system.
Note:
**potentially improvable to 2.00 kbits/s without considering the external temporal filtering system.

Appas, see Appas et al. “Flexible entanglement-distribution network with an AlGaAs chip for secure communications.” (NPJ Quantum Inf. 7, 2021).
Fitzke, see Fitzke et al. “Scalable Network for Simultaneous Pairwise Quantum Key Distribution via Entanglement-Based Time-Bin Coding.” (PRX Quantum 3, 1, 2022).
Schimpf, see Schimpf et al. “Quantum cryptography with highly entangled photons from semiconductor quantum dots.” (Sci. Adv. 7, 1-9, 2021).
Shi, see Shi et al. “Stable polarization entanglement based quantum key distribution over a deployed metropolitan fiber.” (Appl. Phys. Lett. 117, 124002, 2020).
Wen, see Wen et al. “Realizing an Entanglement-Based Multiuser Quantum Network with Integrated Photonics.” (Phys. Rev. Appl. 18, 024059, 2022).
Neumann, see Neumann et al. “Experimentally optimizing QKD rates via nonlocal dispersion compensation.” (Quantum Sci. Technol. 6, 025017, 2021).
Ecker, see Ecker et al. “Strategies for achieving high key rates in satellite-based QKD.” (NPJ Quantum Inf., 71, 5, 2021).
Mishra, see Mishra, S. et al. “BBM92 quantum key distribution over a free space dusty channel of 200 meters” (J. Opt. 24, 2022).

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A device comprising:
a linear series of N optical switches;
N−1 pairs of waveguides wherein each pair of waveguides of the N−1 pairs of waveguides is disposed between a predetermined optical switch of the N optical switches and a sequential optical switch of the N optical switches to the predetermined optical switch of the N optical switches; and
an optical waveguide coupled to the output of the final optical switch of the N optical switches; wherein
each pair of waveguides comprises:
a waveguide coupled from an output port of the associated predetermined optical switch of the N optical switches and an input port of the associated sequential optical switch of the N optical switches; and
another waveguide from another output of the predetermined optical switch of the N optical switches and another input of the associated sequential optical switch of the N optical switches introducing a predetermined delay to optical signals propagating within the another waveguide relative to those optical signals propagating within the waveguide;
the predetermined delays for the N−1 pair of waveguides are 2^{M}·T where M=0, 1 . . . N−1 and T is a defined delay; and
N is a positive integer greater than or equal to 3.

2. The device according to claim 1, wherein
the optical waveguide supports four-wave mixing of the optical signals propagating within it.

3. The device according to claim 1, wherein
the optical waveguide supports four-wave mixing of the optical signals propagating within it; and
the linear series of N optical switches, the N−1 pairs of waveguides and optical waveguide are monolithically integrated.

4. The device according to claim 1, wherein
each optical switch of the linear series of N optical switches is controllable to at least a first switch state to couple the optical signals one of to or from the waveguide and a second switch state to couple the optical signals one of to or from the another waveguide; and
the linear series of N optical switches under appropriate control can establish propagation of the optical signals through a defined subset of the another waveguides of the N−1 another waveguides of the N−1 pairs of waveguides.

5. The device according to claim 1, wherein
the optical waveguide is a spiral waveguide.

6. The device according to claim 1, wherein
each optical switch of the linear series of N optical switches is one of a directional coupler, a zero gap directional coupler, a Mach-Zehnder interferometer, a digital optical switch and a multimode interference switch.

7. A method comprising:
coupling an optical pulse to an optical device to generate a series of optical pulses; and
coupling the series of optical pulses generated by the optical device to an optical waveguide within which spontaneous four-wave mixing of the series of optical pulses occurs to generate signal quantum d-ary bits (qudits) and idler qudits; wherein
d≥2.

8. The method according to claim 7, further comprising
coupling the generated qudits to two or more users where each user accesses a different frequency channel through a demultiplexing scheme applied to the generated qudits.

9. The method according to claim 7, further comprising
coupling the generated qudits to a demultiplexer wherein each output of the demultiplexer represents a different frequency channel and is coupled to an optical link to provide the generated qudits to receiver at a distal end of the optical link.

10. The method according to claim 7, wherein
the optical device comprises:
a linear series of N optical switches; and
N−1 pairs of waveguides wherein each pair of waveguides of the N−1 pairs of waveguides is disposed between a predetermined optical switch of the N optical switches and a sequential optical switch of the N optical switches to the predetermined optical switch of the N optical switches; wherein
the optical waveguide is to the output of the final optical switch of the N optical switches;
each pair of waveguides comprises:
a waveguide coupled from an output port of the associated predetermined optical switch of the N optical switches and an input port of the associated sequential optical switch of the N optical switches; and
another waveguide from another output of the predetermined optical switch of the N optical switches and another input of the associated sequential optical switch of the N optical switches introducing a predetermined delay to optical signals propagating within the another waveguide relative to those optical signals propagating within the waveguide;
the predetermined delays for the N−1 pair of waveguides are 2^{M}·T where M=0, 1 . . . N−1 and T is a defined delay; and
N is a positive integer greater than or equal to 3.

11. The device according to claim 10, wherein
the optical waveguide supports four-wave mixing of the optical signals propagating within it.

12. The device according to claim 10, wherein
the optical waveguide supports four-wave mixing of the optical signals propagating within it; and
the linear series of N optical switches, the N−1 pairs of waveguides and optical waveguide are monolithically integrated.

13. The device according to claim 10, wherein
each optical switch of the linear series of N optical switches is controllable to at least a first switch state to couple the optical signals one of to or from the waveguide and a second switch state to couple the optical signals one of to or from the another waveguide; and
the linear series of N optical switches under appropriate control can establish propagation of the optical signals through a defined subset of the another waveguides of the N−1 another waveguides of the N−1 pairs of waveguides.

14. The device according to claim 10, wherein
the optical waveguide is a spiral waveguide.

15. The device according to claim 10, wherein
each optical switch of the linear series of N optical switches is one of a directional coupler, a zero gap directional coupler, a Mach-Zehnder interferometer, a digital optical switch and a multimode interference switch.
